(19) United States
(12) Patent Application Publication
(10) Pub. No.: US 2008/0240740 A1
(43) Pub. Date: Oct. 2, 2008

(54) IMAGE PROCESSING APPARATUS AND IMAGE PROCESSING SYSTEM

(75) Inventor: Yoko ASANO, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/057,655

(22) Filed: Mar. 28, 2008

(30) Foreign Application Priority Data
Mar. 29, 2007 (JP) 2007-087410

(51) Int. Cl. G03G 15/00; G06F 15/00

(52) U.S. Cl. 399/2; 358/1.15

(57) ABSTRACT

An image processing apparatus is provided that performs image processing based on data received over a prescribed network and includes a number generator generating a number according to a prescribed rule, an apparatus identifier generator using the number generated by the number generator to generate an apparatus identifier distinguishing the image processing apparatus, a communication controller transmitting the apparatus identifier generated by the apparatus identifier generator and receiving address information of a prescribed communication protocol together with the apparatus identifier via the network, and a communication configuration memory storing the address information received by the communication controller, wherein the communication controller uses the address information stored in the communication configuration memory to communicate data with another apparatus on the network.

### BACKGROUND OF THE INVENTION

1. Area of the Invention

The present invention relates to an image processing apparatus and an image processing system performing image processing based on data received over a network.

2. Description of Related Art

TCP/IP (Transmission Control/Internet Protocol) has been predominantly used as a protocol in a computer network such as LAN (Local Area Network) and the like on which multiple terminal apparatuses and multiple image processing apparatuses are connected with each other, and various technologies for the TCP/IP such as Japanese Patent No. 3645401 have been suggested. On a TCP/IP network, an identifier or so-called IP address is assigned to each of the apparatuses such as the terminal apparatus, the image processing apparatus, and the like to uniquely distinguish each of the apparatuses, and the apparatus on the TCP/IP network uses the IP address as the destination address of communication to communicate with each other. Accordingly, the IP address must be assigned to each of the apparatuses before the apparatus communicates on the TCP/IP network.

The IP address of each of the apparatuses must be configured by a user with an operation panel, switches, and the like arranged on the apparatuses, and thus, there raises a problem that the user is forced to do cumbersome IP address configuration.

### SUMMARY OF THE INVENTION

This invention is made to solve such problems, and it is the object of the present invention to provide the image processing apparatus and the image processing system allowing easy and reliable configuration of the IP addresses.

The image processing apparatus of the present invention achieving the above-mentioned object includes an image processing apparatus performing image processing based on data received over a prescribed network, the image processing apparatus comprising, a number generator generating a number according to a prescribed rule, an apparatus identifier generator generating an apparatus identifier distinguishing the image processing apparatus based on the number generated by the number generator, a communication controller transmitting the apparatus identifier generated by the apparatus identifier generator and receiving address information of a prescribed communication protocol transmitted in response to the apparatus identifier via the network, and a communication configuration memory storing the address information received by the communication controller, wherein the communication controller uses the address information stored in the communication configuration memory to communicate data with another apparatus on the network.

In the image processing apparatus of the present invention, the apparatus identifier generator generates the apparatus identifier, and where the image processing apparatus transmits the apparatus identifier, address information corresponding to the apparatus identifier is transmitted. The communication controller uses the received address information as address information for performing data communication. In this way, the image processing apparatus of the present invention can change configuration of the address information over the network.

The image processing system of the present invention achieving the above-mentioned object includes a host apparatus connected to a prescribed network, and an image processing apparatus performing image processing based on data received from the host apparatus via the network, wherein the image processing apparatus includes a number generator generating a number according to a prescribed rule, an apparatus identifier generator generating an apparatus identifier distinguishing the image processing apparatus based on the number generated by the number generator, a communication controller transmitting the apparatus identifier generated by the apparatus identifier generator and receiving address information of a prescribed communication protocol transmitted in response to the apparatus identifier via the network, and a communication configuration memory storing the address information received by the communication controller, and wherein the communication controller uses the address information stored in the communication configuration memory to communicate data with the host apparatus via the network.

In the image processing system of the present invention, where the image processing apparatus generates the apparatus identifier and transmits the generated apparatus identifier to the host apparatus, the host apparatus transmits the address information to the image processing apparatus in response to the apparatus identifier. The image processing apparatus uses the received address information as the address information for performing data communication. In this way, the image processing system can change the address information configuration over the network.

In the image processing apparatus and system of the present invention, the user does not need to configure the apparatus identifier distinguishing the image processing system on the network, and the address information can be configured easily and reliably without requiring the user to do cumbersome work.

### DETAILED DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

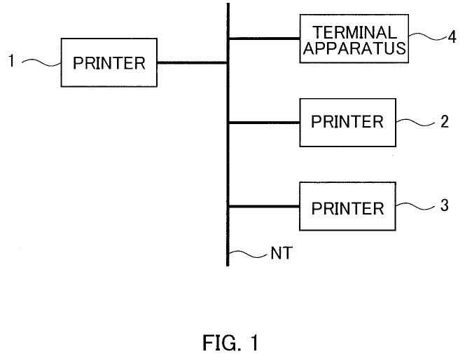

FIG. 1 is a block diagram describing the image processing system according to the first embodiment of the present invention;

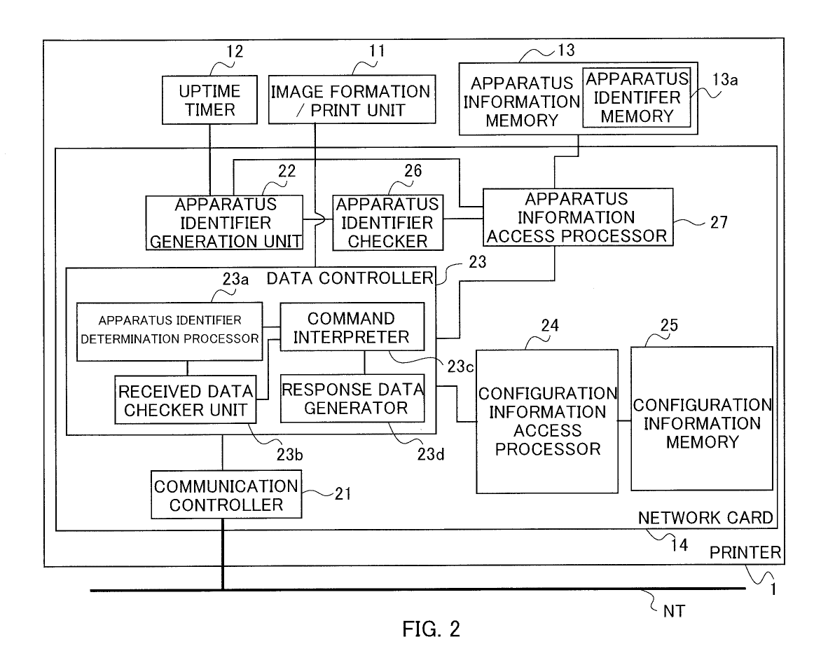

FIG. 2 is a block diagram describing the structure of a printer of the image processing system according to the first embodiment of the present invention;

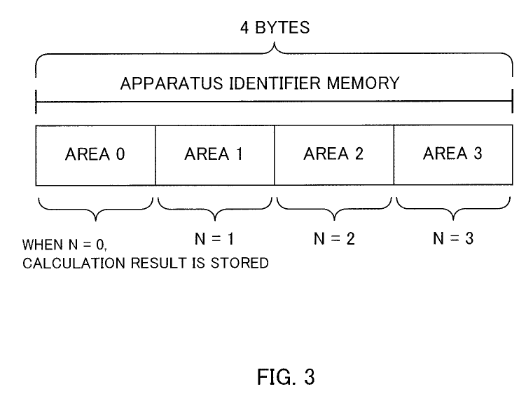

FIG. 3 is a schematic diagram describing the structure of an apparatus identifier memory in the printer shown in FIG. 2;

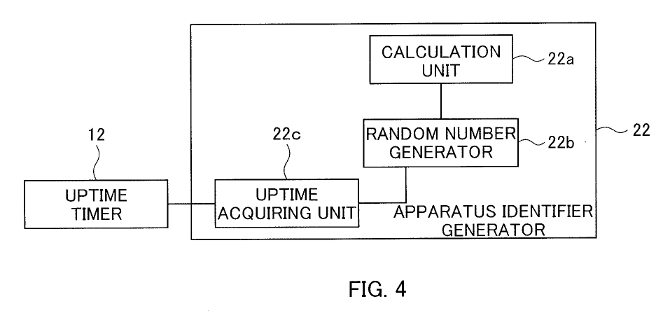

FIG. 4 is a block diagram describing the apparatus identifier generator in the printer shown in FIG. 2;

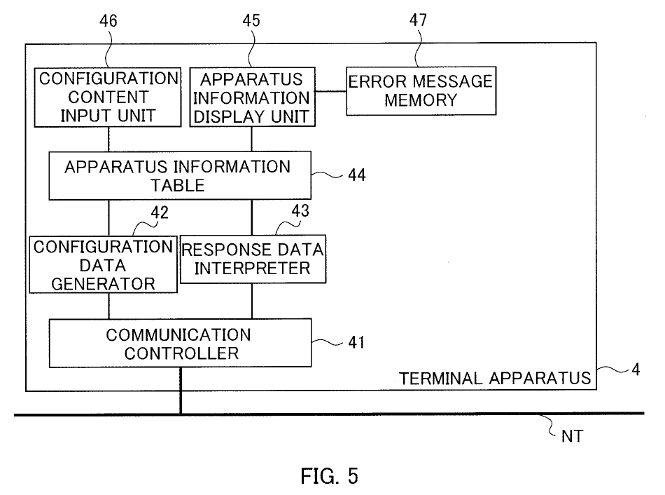

FIG. 5 is a block diagram describing the structure of a terminal apparatus of the image processing system according to the first embodiment of the present invention;

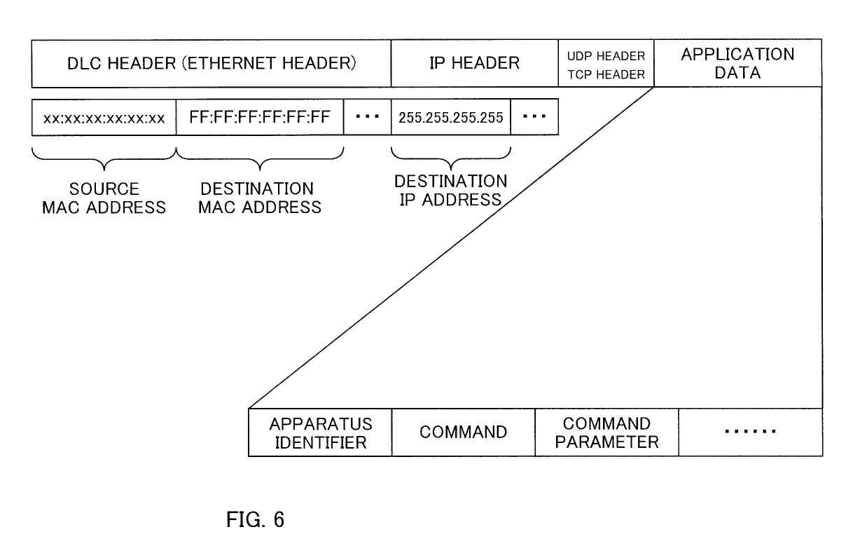

FIG. 6 is figure describing the structure of the configuration data transmitted from the terminal apparatus to the printer in the image processing system according to the first embodiment of the present invention;

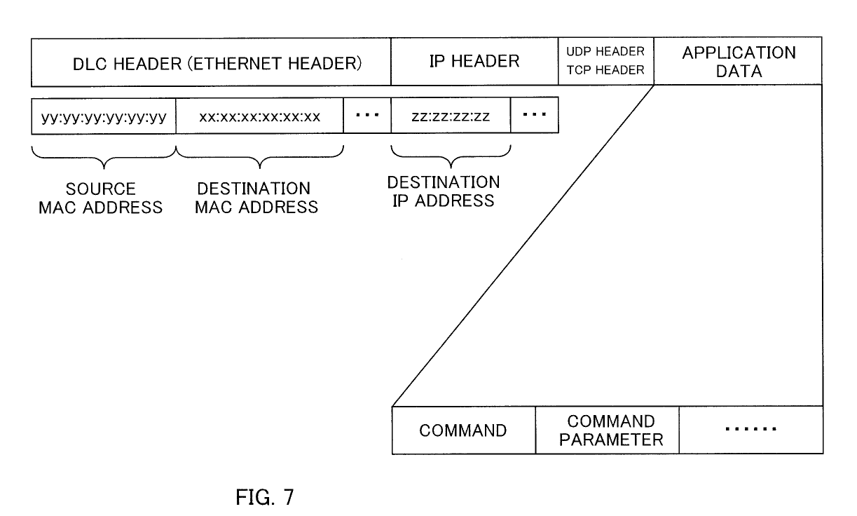

FIG. 7 is a diagram describing the structure of the response data transmitted from the printer to the terminal apparatus in the image processing system according to the first embodiment of the present invention;

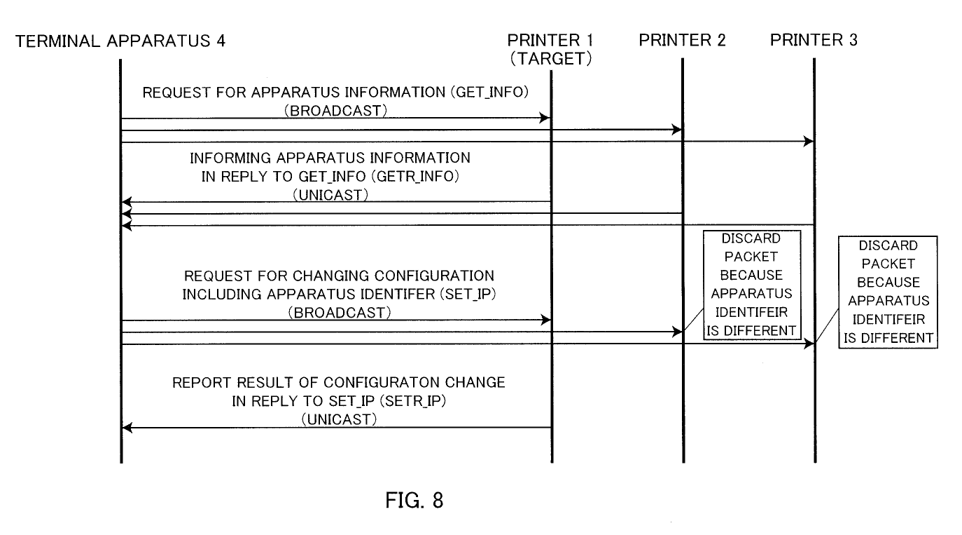

FIG. 8 is a diagram showing data exchange between the printer and the terminal apparatus where no duplicate apparatus identifier exists among the response data in the image processing system according to the first embodiment of the present invention;

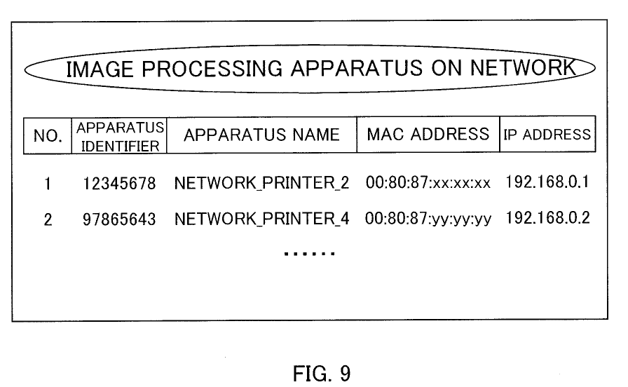

FIG. 9 is a diagram describing an example of a screen displayed by the apparatus information display unit in the terminal apparatus shown in FIG. 5.

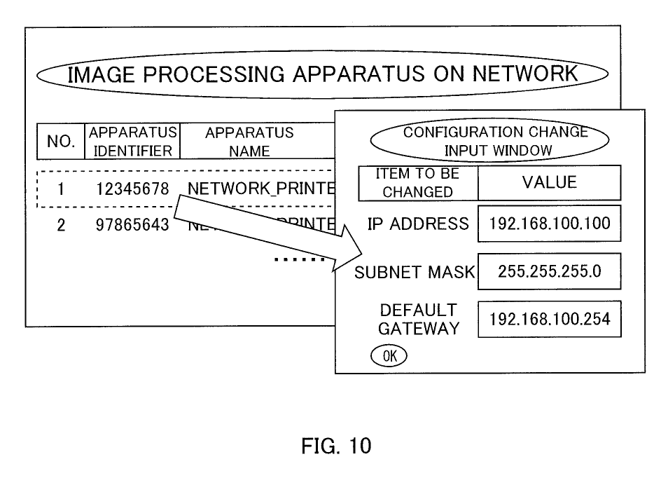

FIG. 10 is a diagram describing an example of a screen displayed by the apparatus information display unit in the terminal apparatus shown in FIG. 5 when a configuration change input window pops up.

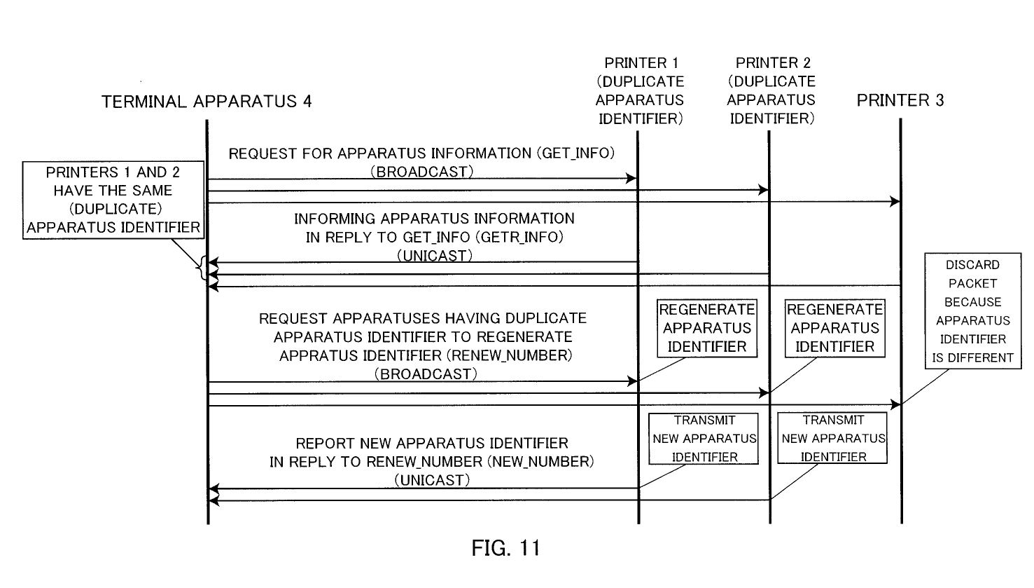

FIG. 11 is a diagram showing data exchange between the printer and the terminal apparatus where the duplicate apparatus identifier is detected in the response data in the image processing system according to the first embodiment of the present invention;

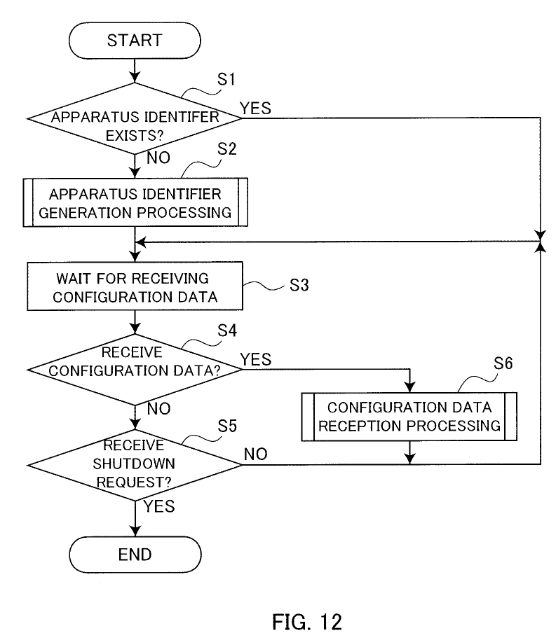

FIG. 12 is a flowchart describing basic operation of the printer of the image processing system according to the first embodiment of the present invention;

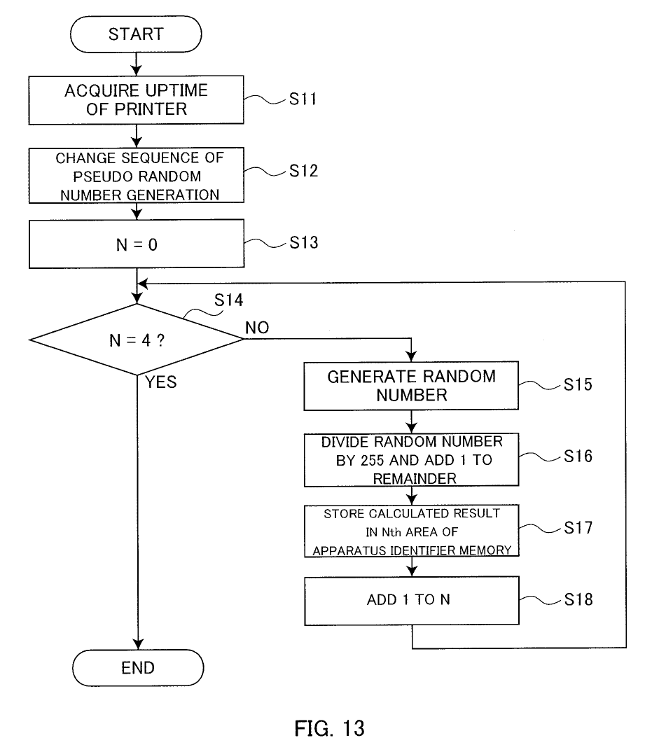

FIG. 13 is a flowchart describing apparatus identifier generation processing performed by the printer of the image processing system according to the first embodiment of the present invention;

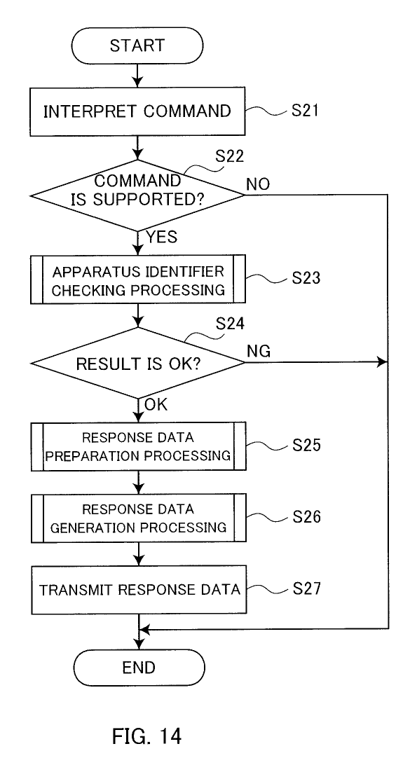

FIG. 14 is a flowchart describing configuration data reception processing performed by the printer of the image processing system according to the first embodiment of the present invention;

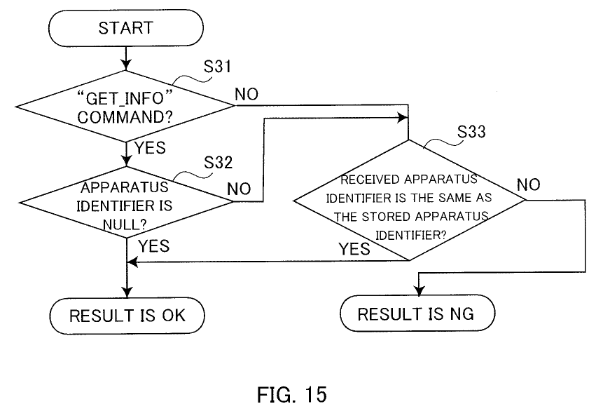

FIG. 15 is a flowchart describing the apparatus identifier checking processing performed by the printer of the image processing system according to the first embodiment of the present invention;

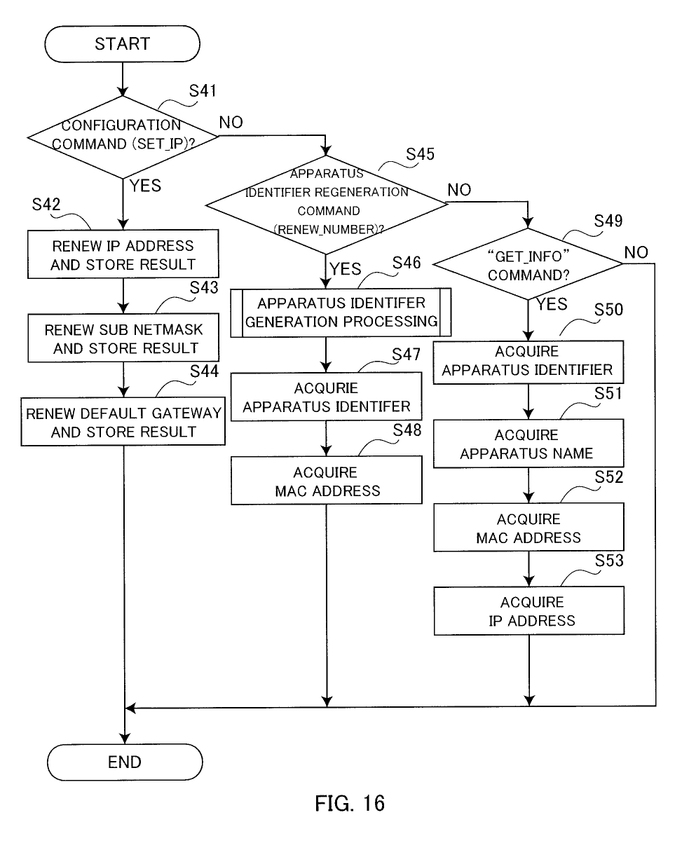

FIG. 16 is a flowchart describing response data preparation processing performed by the printer of the image processing system according to the first embodiment of the present invention;

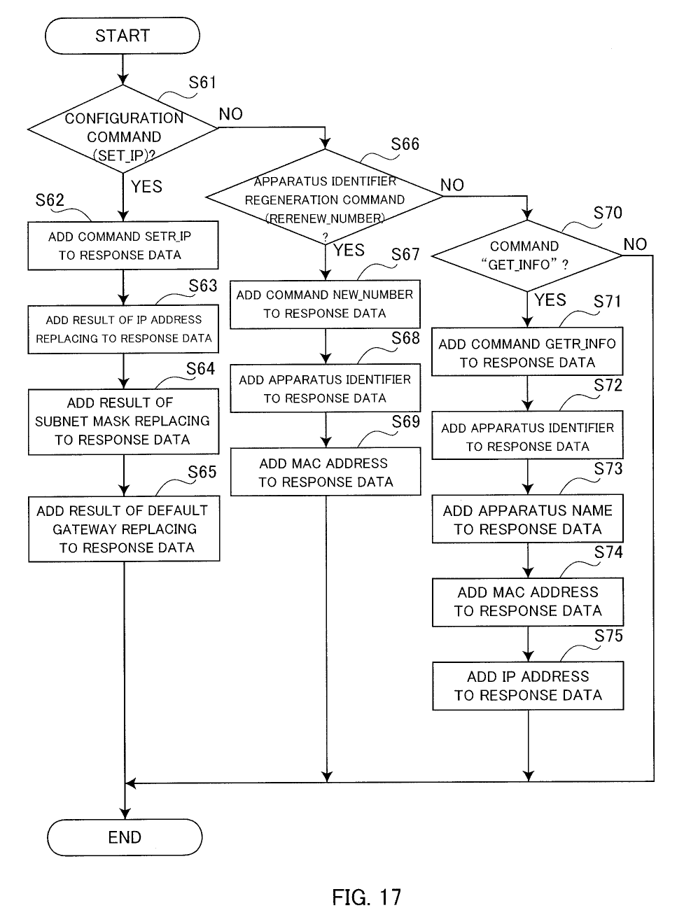

FIG. 17 is a flowchart describing response data generation processing performed by the printer of the image processing system according to the first embodiment of the present invention;

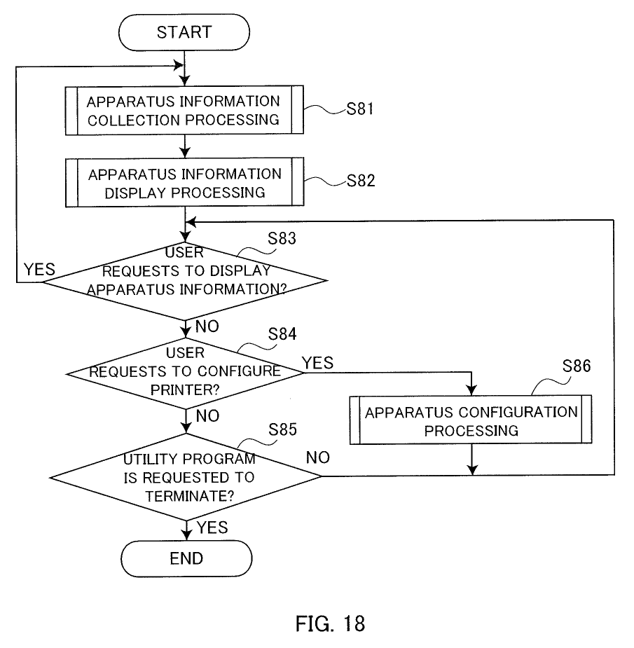

FIG. 18 is a flowchart describing basic operation of the terminal apparatus of the image processing system according to the first embodiment of the present invention;

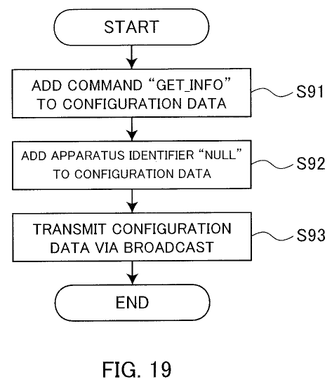

FIG. 19 is a flowchart describing apparatus information collection processing performed by the terminal apparatus of the image processing system according to the first embodiment of the present invention;

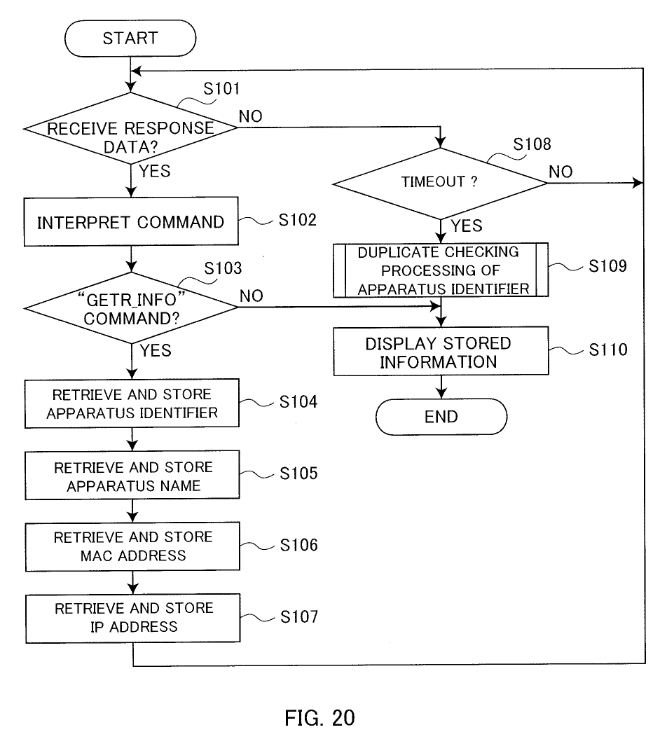

FIG. 20 is a flowchart describing apparatus information display processing performed by the terminal apparatus of the image processing system according to the first embodiment of the present invention;

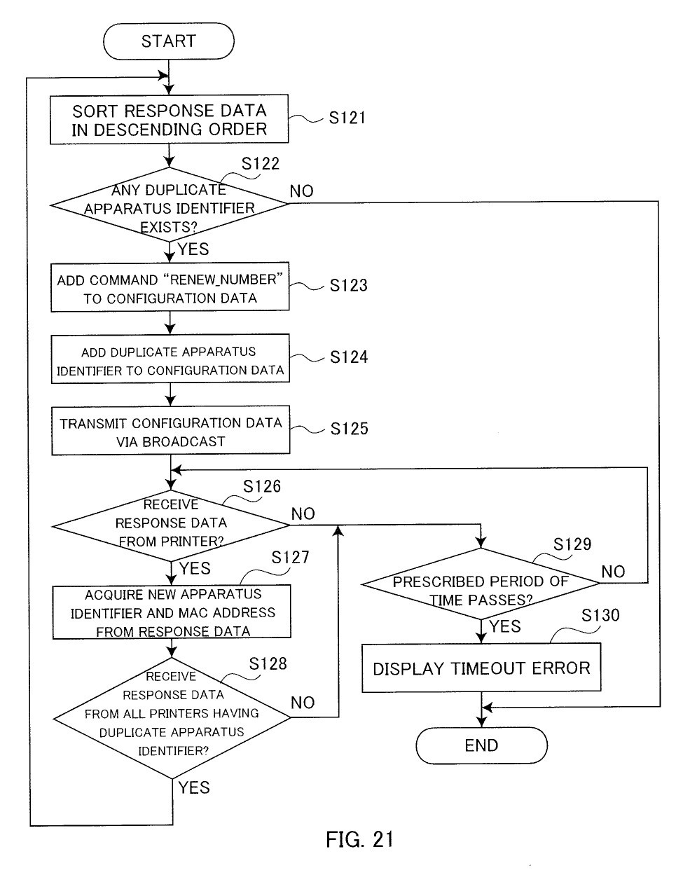

FIG. 21 is a flowchart describing duplicate checking processing of the apparatus identifier performed by the terminal apparatus of the image processing system according to the first embodiment of the present invention;

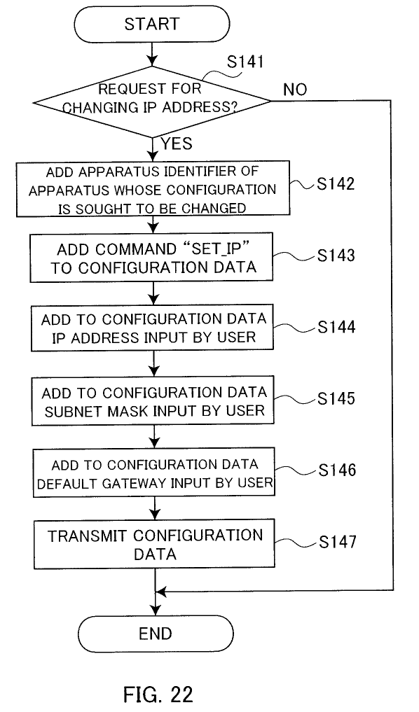

FIG. 22 is a flowchart describing apparatus configuration processing performed by the terminal apparatus of the image processing system according to the first embodiment of the present invention;

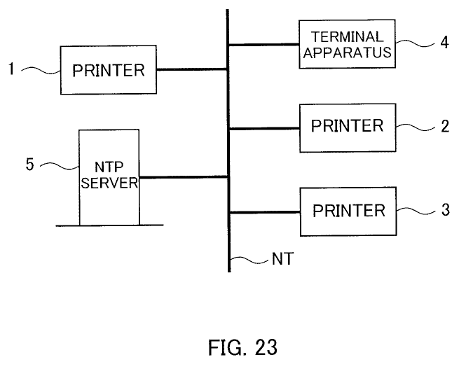

FIG. 23 is a block diagram describing the structure of the image processing system according to the second embodiment of the present invention;

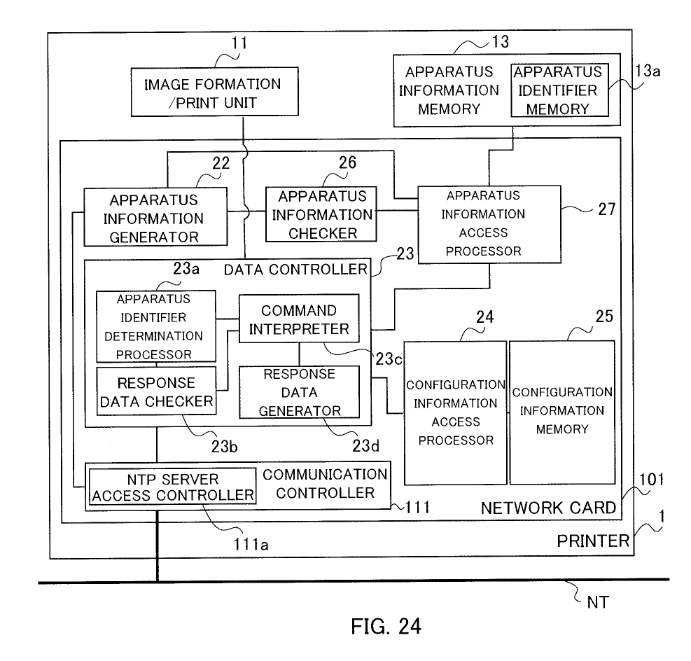

FIG. 24 is a block diagram describing the structure of the printer of the image processing system according to the second embodiment of the present invention;

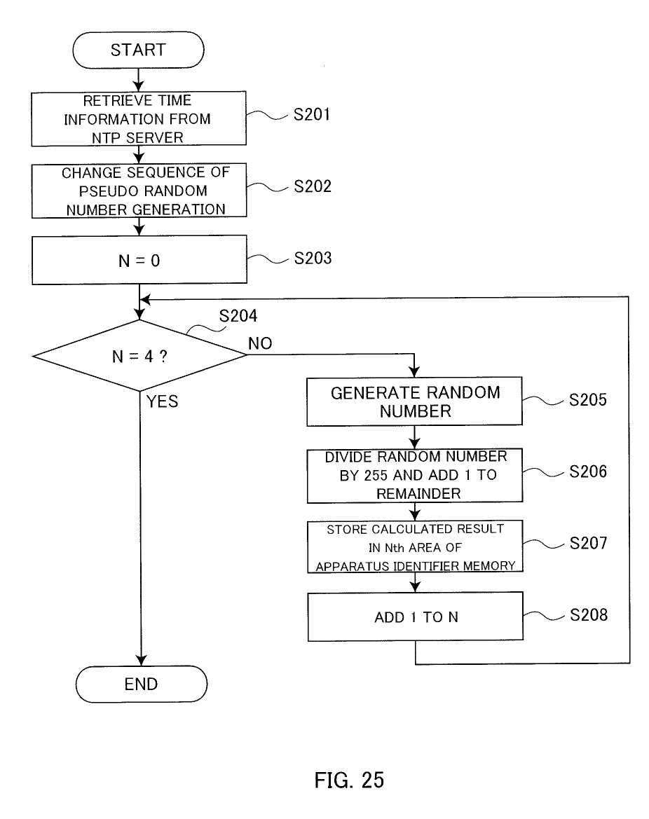

FIG. 25 is a flowchart describing the apparatus identifier generation processing performed by the printer of the image processing system according to the second embodiment of the present invention;

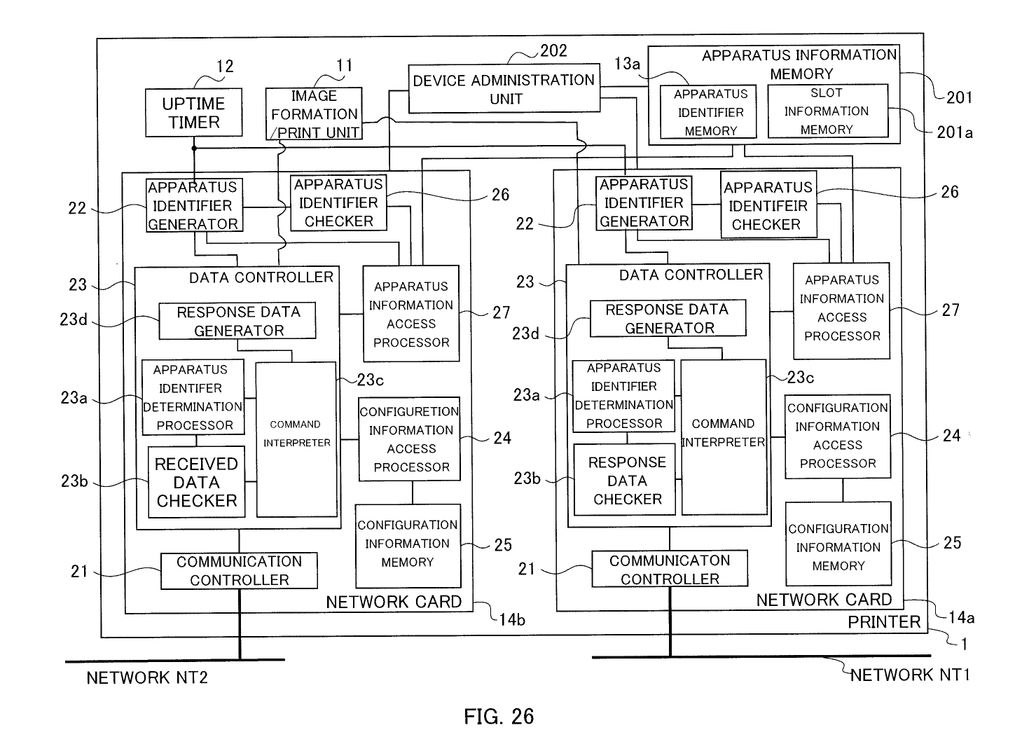

FIG. 26 is a block diagram describing the structure of the printer of the image processing system according to the third embodiment of the present invention;

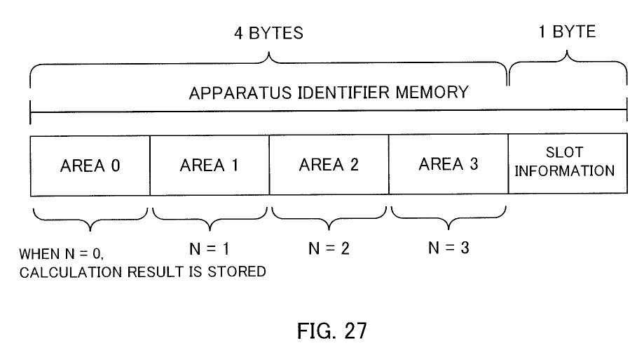

FIG. 27 is a schematic diagram describing the structure of the apparatus identifier memory in the printer of the image processing system according to the third embodiment of the present invention;

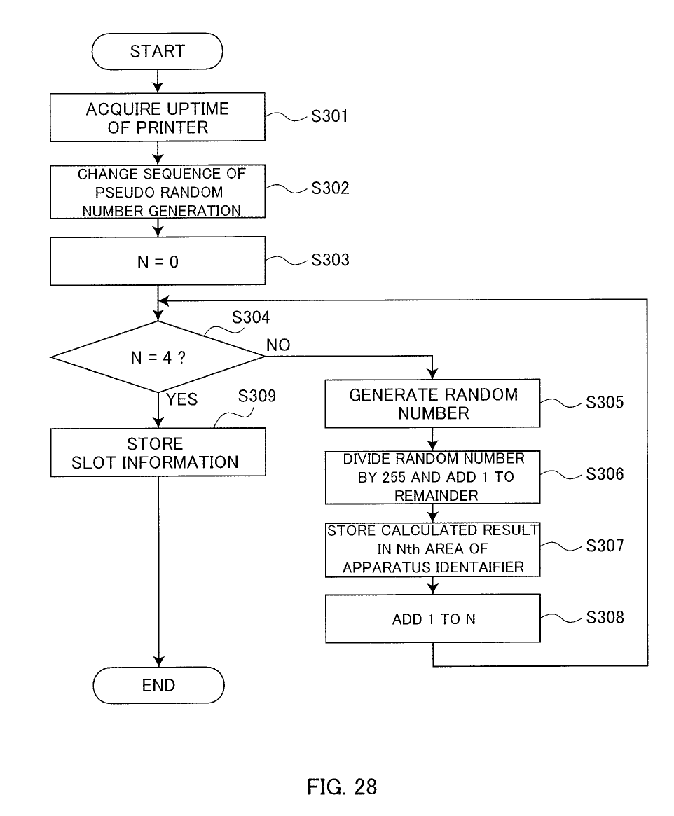

FIG. 28 is a flowchart describing the apparatus identifier generation processing of the printer of the image processing system according to the third embodiment of the present invention;

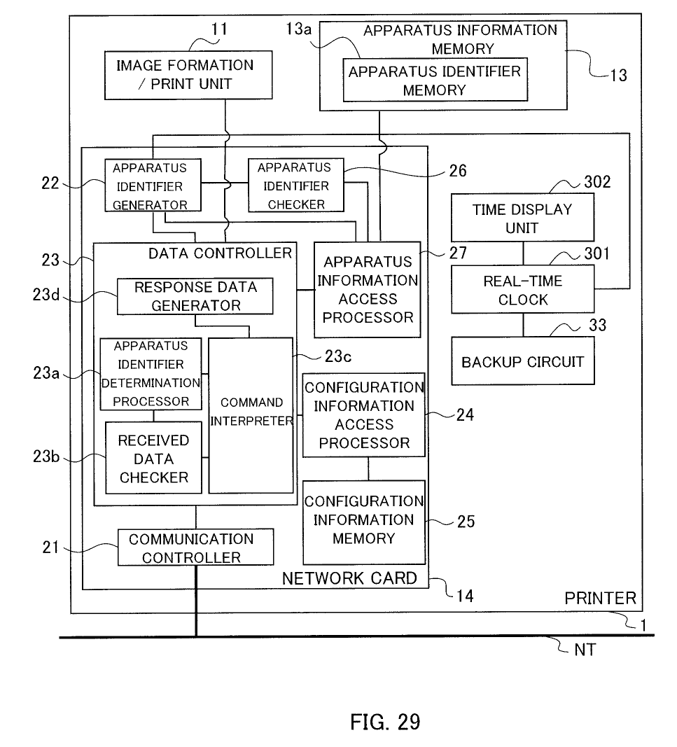

FIG. 29 is a block diagram describing the structure of the printer of the image processing system according to the fourth embodiment of the present invention; and

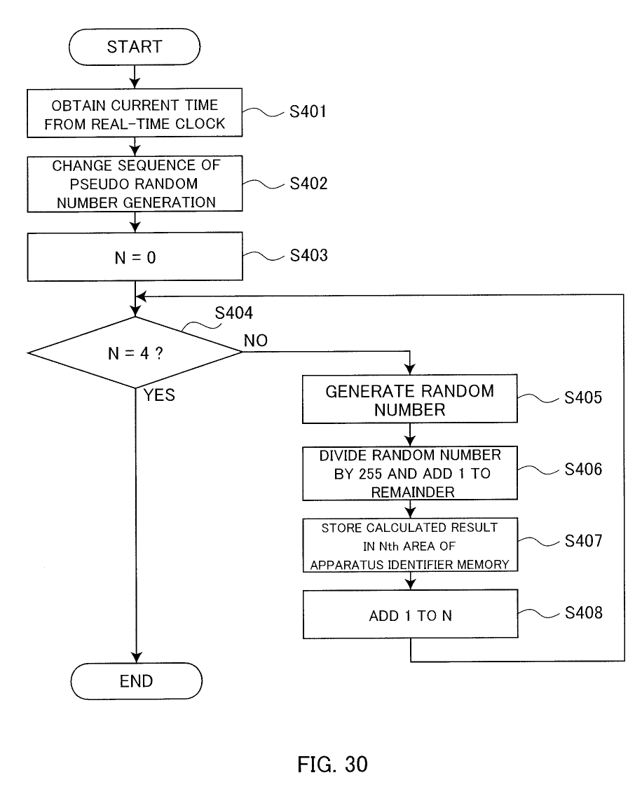

FIG. 30 is a flowchart describing the apparatus identifier generation processing performed by the printer of the image processing system according to the fourth embodiment of the present invention.

### PREFERRED EMBODIMENTS

The embodiments of the present invention will be hereinafter described in detail with reference to figures.

The present embodiment describes the image processing system having a printer serving as the image processing apparatus according to the present invention. The present invention is applied to a network card serving as a network interface unit of the printer.

The image processing system of the first embodiment of the present invention is hereinafter described.

The image processing system includes the multiple printers 1 to 3 and a terminal apparatus 4 serving as the host apparatus of the printers 1 to 3, and the printers 1 to 3 and the terminal apparatus 4 are connected with each other over a prescribed network NT such as LAN (Local Area Network) and the like as shown in FIG. 1.

FIG. 2 is a block diagram of the printers 1 to 3. Only the internal configuration of the printer 1 is hereinafter described because all of the printers 1 to 3 have substantially the same internal configuration.

The printer 1 has an image formation/print unit 11 forming an image on a prescribed recording medium such as paper based on data input externally, an uptime timer 12 measuring an uptime since the printer 1 is turned on, an apparatus information memory 13 storing information about the printer 1 including an apparatus identifier of the printer 1, and a network card 14, detachable from the printer 1, serving as the network interface unit communicating over the network NT.

The image formation/print unit 11 prints an image on the prescribed recording medium such as paper based on print data transmitted from the terminal apparatus 4 and the like over the network NT. For example, where the printer employs electrophotographic printing, the image formation/print unit 11 is a series of mechanisms for forming the image on the recording medium with a charged toner and fusing the formed toner image onto the recording medium to print the image on the recording medium. Where the printer employs ink-jet printing, the image formation/print unit 11 is a series of mechanisms for propelling droplets of ink onto the recording medium to print the image on the recording medium.

The uptime timer 12 is the timer measuring the uptime since the printer 1 is turned on. The uptime measured by the uptime timer 12 is supplied to an apparatus identifier generator 22 of the network card 14 hereinafter described.

The apparatus information memory 13 has an apparatus identifier memory 13a storing the apparatus identifier of the printer 1, and the apparatus information memory 13 stores information about the printer 1 including the apparatus identifier and apparatus name such as product name of the printer 1 and the like. As shown in FIG. 3, the size of the apparatus identifier memory 13a is a prescribed number of bytes, and the apparatus identifier memory 13a has as many areas as the number N of times of pseudorandom number generation hereinafter described, and stores information generated by the apparatus identifier generator 22 in each of the areas under the control of an apparatus information access processor 27 in the network card 14 hereinafter described. It is to be noted that FIG. 3 shows a case where N=4 and the apparatus identifier memory 13a has the four one-byte areas for storing the information. The apparatus identifier is thus made by combing the information stored in each of the areas. The apparatus information access processor 27 reads out the apparatus identifier stored in the apparatus identifier memory 13a.

The network card 14 has a communication controller 21 controlling communication with other apparatuses, the apparatus identifier generator 22 generating the apparatus identifier of the printer 1, a data controller 23 generating data to be transmitted to other apparatuses via the communication controller 21 and performing processing of data received from other apparatuses via the communication controller 21, a configuration information access processor 24 performing actual configuration change processing where the received data is interpreted by the data controller 23 and determined to be a request for changing configuration information as hereinafter described, a configuration information memory 25 storing the configuration information about the printer 1 to serve as a communication configuration memory, an apparatus identifier checker 26 determining whether the apparatus identifier is already stored at startup of the printer 1, and the apparatus information access processor 27 writing data to the apparatus information memory 13 and reading data from the apparatus information memory 13.

The communication controller 21 controls communication with other apparatuses such as the terminal apparatus 4 and the like connected to the network NT. Specifically, the communication controller 21 transmits the data generated by the data controller 23 to other apparatuses over the network NT, receives data transmitted from other apparatuses over the network NT, and supplies the received data to the data controller 23.

As shown in FIG. 4, the apparatus identifier generator 22 has a calculation unit 22a performing prescribed computations, a random number generator 22b generating pseudo random numbers, and an uptime acquiring unit 22c acquiring an uptime information. Where the apparatus identifier generator 22 receives a command for requesting regeneration of the apparatus identifier or the apparatus identifier checker 26 determines that the apparatus identifier memory 13a of the apparatus information memory 13 does not store the apparatus identifier, the apparatus identifier generator 22 makes the uptime acquiring unit 22c acquire the uptime of the printer 1 from the uptime timer 12. Subsequently, the apparatus identifier generator 22 initializes the random number generator 22b using the uptime information acquired by the uptime acquiring unit 22c as random seed or seed state of pseudo random numbers, makes the random number generator 22b generate the pseudo random numbers, makes the calculation unit 22a perform computations to process the generated pseudo random numbers, and generates the apparatus identifier of the printer 1. The apparatus identifier generator 22 stores the generated apparatus identifier in the apparatus identifier memory 13a of the apparatus information memory 13 via the apparatus information access processor 27.

The data controller 23 has: an apparatus identifier determination processor 23a determining whether the apparatus identifier included in data received from other apparatus via the communication controller 21 is NULL or whether the received apparatus identifier is the same as the apparatus identifier stored in the apparatus identifier memory 13a; a received data checker 23b determining whether a command included in the received data is supported; a command interpreter 23c interpreting the command included in the received data; and a response data generator 23d generating response data based on a result of processing of the received data. When the data controller 23 receives the data from other apparatuses via the communication controller 21, the data controller 23 makes the command interpreter 23c interpret the command, and at the same time, the received data checker 23b determines whether the command included in the received data is supported. Where the command is determined not to be supported, the data controller 23 discards the receive data. On the other hand, the command included in the received data is determined to be supported, the data controller 23 makes the apparatus identifier determination processor 23a determine whether the apparatus identifier included in the received data is NULL or whether the received apparatus identifier is the same as the apparatus identifier stored in the apparatus identifier memory 13a, and depending on the command, the data controller 23 controls the configuration information access processor 24 and reads out the apparatus identifier stored in the apparatus identifier memory 13a. Subsequently, the data controller 23 makes the response data generator 23d generate the response data based on the result of processing of the received data, and transmits the response data to other apparatus via the communication controller 21. Further, the data controller 23 passes the image data between the image formation/print unit 11 and the communication controller 21.

The configuration information access processor 24 writes the configuration information such as the IP (Internet Protocol) address of the printer 1 to the configuration information memory 25 so that the written IP address and the like are set as the address information of the printer 1, and reads out the configuration information stored in the configuration information memory 25. Where the data controller 23 interprets the command in the received data to determine that the command is the request for changing the configuration information, the configuration information access processor 24 performs processing for changing the configuration information stored in the configuration information memory 25.

The configuration information memory 25 stores the configuration information such as the IP address of the printer 1 under the control of the configuration information access processor 24. The configuration information access processor 24 reads out the configuration information stored in the configuration information memory 25.

The apparatus identifier checker 26 accesses the apparatus identifier memory 13a via the apparatus information access processor 27 at startup of the printer 1 to determine whether the apparatus identifier is already stored in the apparatus identifier memory 13a. The apparatus identifier checker 26 supplies to the apparatus identifier generator 22 information as to whether the apparatus identifier is stored in the apparatus identifier memory 13a.

The apparatus information access processor 27 writes data such as the apparatus identifier to the apparatus information memory 13 and reads data stored in the apparatus information memory 13 under the control of the apparatus identifier generator 22, the apparatus identifier checker 26, and the like.

The network card 14 having various units as described above is arranged on the printer 1 to be detachable from the printer 1, and communicates with other apparatuses over the network NT.

The printer 1 as described above changes the configuration of itself by performing processing as hereinafter described based on the data received from the terminal apparatus 4 connected via the network NT. It should be noted that the other printers 2 and 3 are substantially the same as the printer 1.

On the other hand, as shown in FIG. 5, the terminal apparatus 4 has a communication controller 41 controlling communication with other apparatuses, a configuration data generator 42 generating configuration data to be transmitted to the printers 1 to 3, a response data interpreter 43 interpreting the response data transmitted from the printers 1 to 3, an apparatus information table 44 storing apparatus information about the printers 1 to 3 interpreted by the response data interpreter 43, an apparatus information display unit 45 displaying apparatus information stored in the apparatus information table 44, a configuration content input unit 46 allowing a user to input information as to selection of one of the printers 1 to 3 targeted for configuration change and information of the content of the configuration change of the targeted printer, and an error message memory 47 storing error messages describing errors when errors occur.

The communication controller 41 controls communication with other apparatuses such as the printers 1 to 3 and the like connected to the network NT. Specifically, the communication controller 41 transmits the configuration data generated by the configuration data generator 42 to the printers 1 to 3 over the network NT, receives the response data transmitted from the printers 1 to 3 over the network NT, and supplies the received data to the response data interpreter 43.

The configuration data generator 42 generates the configuration data to be transmitted to the printers 1 to 3 based on the apparatus information stored in the apparatus information table 44. It is to be noted that the configuration data includes various commands for changing the configuration of the printers 1 to 3, which examples are hereinafter described. The configuration data generator 42 transmits the generated configuration data to the printers 1 to 3 via the communication controller 41.

The response data interpreter 43 interprets the response data received from the printers 1 to 3 via the network controller 41. The response data interpreter 43 writes the apparatus information to the apparatus information table 44 based on the result of interpretation of the command included in the response data.

The apparatus information table 44 is controlled by the response data interpreter 43, and stores the apparatus information such as the apparatus identifiers, MAC (Media Access Control) addresses, IP addresses, and the like of the printers 1 to 3 having transmitted the response data. The apparatus information stored in the apparatus information table 44 is supplied to the apparatus information display unit 45.

The apparatus information display unit 45 displays the apparatus information stored in the apparatus information table 44. The apparatus information display unit 45 reads out and displays the error messages stored in the error message memory 47 when errors occur.

The configuration content input unit 46 allows a user to input the information as to selection of one of the printers 1 to 3 targeted for the configuration change and the information of the content of configuration change with a prescribed input peripheral device such as keyboard, mouse, and the like. The configuration content input unit 46 supplies the information input by the user to the configuration data generator 42 via the apparatus information table 44.

The error message memory 47 stores the error messages to be displayed on the apparatus information display unit 45 when errors occur. The error messages stored in the error message memory 47 are read out by the apparatus information display unit 45.

Where the configuration of the printers 1 to 3 connected via the network NT are to be changed, the terminal apparatus 4 performs processing as hereinafter described to transmit the configuration data to the printers 1 to 3 and receives the response data transmitted from the printers 1 to 3.

In the image processing system having the printers 1 to 3 and the terminal apparatus 4, the terminal apparatus 4 transmits the configuration data to the printers 1 to 3 to change the configuration of the printers 1 to 3. Specifically, the configuration data is an IP (Internet Protocol) packet or datagram encapsulated in an Ethernet frame, and as shown in FIG. 6, the configuration data consists of a DLC (Data Link Control) header, i.e., an Ethernet header, including the source MAC addresses of the terminal apparatus 4 and the destination MAC address of the printer (the network card 14), an IP header including the source IP address of the terminal apparatus 4 and the destination IP address of the printer, a UDP (User Datagram Protocol) or TCP (Transmission Control Protocol) header, and application data. The configuration data is transmitted to the broadcast address so that all of the printers 1 to 3 receive the configuration data. That is, the configuration data has the destination MAC address FF:FF:FF:FF:FF:FF in the Ethernet header and the destination IP address 255.255.255.255 in the IP header. The application data includes the apparatus identifier, the command, command parameters, and the like. The commands and the parameters are shown in Table 1 below. The commands are: GET_INFO for requesting the apparatus information such as the apparatus identifier, the MAC address, the IP address, and the like of the destination printer connected to the network NT; SET_IP taking parameters such as the apparatus identifier, the apparatus name, the new IP address, and the like of the destination printer for changing the IP address, the subnet mask, and the default gateway to the new values specified as the parameters; RENEW_NUMBER taking the current apparatus identifier as the parameter for requesting regeneration of the new apparatus identifier in place of the current apparatus identifier; and the like.

TABLE 1
The commands and the parameters of the commands in the configuration data

| Command | Parameter | Description |
|---|---|---|
| GET_INFO | No parameter | Request the apparatus identifier, |
| | | the MAC address, and the IP |
| | | address |
| SET_IP | The apparatus identifier of the | |
| | printer whose configuration is | |
| | sought to be changed | |
| | XXX.XXX.XXX.XXX | Change the IP address to |
| | | XXX.XXX.XXX.XXX |
| | YYY.YYY.YYY.YYY | Change the subnet mask to |
| | | YYY.YYY.YYY.YYY |
| | ZZZ.ZZZ.ZZZ.ZZZ | Change the default gateway to |
| | | ZZZ.ZZZ.ZZZ.ZZZ |
| | Apparatus name | |
| RENEW_NUMBER | The current apparatus identifier of | Request generation of the new |
| | the printer | apparatus identifier in place of the |
| | | current apparatus identifier |

In the image processing system, each of the printers 1 to 3 receiving the configuration data makes and transmits the response data to the terminal apparatus 4 as an unicast packet. Specifically, the response data is the IP (Internet Protocol) packet or datagram encapsulated in the Ethernet frame, and as shown in FIG. 6, the response data consists of the DLC (Data Link Control) header, i.e., the Ethernet header, including the source MAC addresses of the printer (the network card 14) and the destination MAC address of the terminal apparatus 4, the IP header including the source IP address of the printer and the destination IP address of the terminal apparatus 4, the UDP (User Datagram Protocol) or TCP (Transmission Control Protocol) header, and the application data.

The application data consists of the commands, the parameters of the commands, and the like. The commands and the parameters are as shown in Table 2 below. The commands are: GETR_INFO for replying the apparatus identifier, the MAC address, the IP address, and the like of the printer of itself in response to the command GET_INFO; SETR_IP replying whether the change of the IP address, the subnet mask, and the default gateway has been successfully finished in response to the command SET_IP; NEW_NUMBER replying the MAC address and the new apparatus identifier after regeneration of the apparatus identifier in response to the command RENEW_NUMBER; and the like.

TABLE 2
The commands and the parameters of the commands
in the response data

| Command | Parameter | Description |
|---|---|---|
| GETR_INFO | XXXXXXXX | Reply the apparatus |
| | XX:XX:XX:XX:XX:XX | identifier, the MAC |
| | XXX.XXX.XXX.XXX | address, and the |
| | | IP address |
| SETR_IP | OK/NG | Reply whether the change |
| | | of the IP address, the |
| | | subnet mask, and the |
| | | default gateway has been |
| | | successfully finished or not |
| NEW_NUMBER | XXXXXXXX | Reply the MAC address |
| | XX:XX:XX:XX:XX:XX | and the new apparatus |
| | | identifier after regeneration |
| | | of the apparatus |
| | | identifier |

In the image processing system thus transmitting and receiving the data, the user operates the terminal apparatus 4 to run a prescribed printer administration utility program to call the configuration data generator 42. The configuration data generator 42 generates the configuration data including the above-described GET_INFO command and the apparatus identifier “NULL” to retrieve the apparatus information of all the apparatuses, namely, the printers 1 to 3 on the network NT. Then, the terminal apparatus 4 transmits the configuration data as the broadcast packet to the network NT via the communication controller 41 as shown in FIG. 8.

When the printers 1 to 3 receive the configuration data transmitted from the terminal apparatus 4 over the network controller 21, each of the printers 1 to 3 calls the received data checker 23b. The received data checker 23b calls the command interpreter 23c to interpret the command included in the configuration data and determines whether the command is supported. In this case, the command is the GET_INFO command which is supported, and accordingly, the received data checker 23b does not discard the received configuration data but calls the apparatus identifier determination processor 23a. The apparatus identifier determination processor 23a accepts the configuration data because the apparatus identifier included in the configuration data is “NULL.” Then, the apparatus identifier determination processor 23a calls the apparatus information access processor 27 to read the apparatus identifier stored in the apparatus identifier memory 13a, calls the configuration information access processor 24 to read the configuration information such as the IP address and the like of the apparatus of itself stored in the configuration information memory 25, and calls the response data generator 23d passing the apparatus identifier and the information read out of the configuration information memory 25 as parameters. Then, the response data generator 23d generates the response data including the above-described command GETR_INFO in response to the GET_INFO command. Then, each of the printers 1 to 3 transmits the response data via the network controller 21 to the terminal apparatus 4 as the unicast packet as shown in FIG. 8.

Each of the printers 1 to 3 transmits to the terminal apparatus 4 via unicast the response data in response to the configuration data transmitted via broadcast by the terminal apparatus 4. The source IP address, not shown, in the IP header of the configuration data is used as the destination address of the response data. It should be noted that where a router and the like exists between the terminal apparatus 4 and the printers 1 to 3, the IP address in the IP header of the configuration data may be re-written. To cope with such network configuration, the IP address of the terminal 4 may be recited not only in the IP header but also in the application data of the configuration data transmitted from the terminal apparatus 4 via broadcast to enable the printers 1 to 3 to obtain the IP address of the terminal apparatus 4 by referring to the IP address recited in the application data and to reply to the IP address.

When the terminal apparatus 4 receives the response data transmitted from each of the printers 1 to 3 via the communication controller 41, the terminal apparatus 4 calls the response data interpreter 43. The response data interpreter 43 interprets the command included in the response data, and where the command is GETR_INFO, the response data interpreter 43 determines whether any duplicate apparatus identifier exists among the multiple response data. Where no duplicate apparatus identifier exists, the response data interpreter 43 retrieves the apparatus identifier, the MAC address, the IP address, and the like recited as the parameters in the response data, and stores these information about the apparatus in the apparatus information table 44 as described in Table 3 below. If the content in the apparatus information table 44 is renewed, the terminal apparatus 4 notifies the apparatus information display unit 45 to that effect, and the content of the apparatus information table 44 is displayed as sown in FIG. 9.

TABLE 3
The content of the Apparatus Information Memory

| No. | Apparatus Identifier | Apparatus Name | MAC address | IP address |
|---|---|---|---|---|
| 1 | 12345678 | NETWORK_PRINTER_2 | 00:80:87:xx:xx:xx | 192.168.0.1 |
| 2 | 97865643 | NETWORK_PRINTER_4 | 00:80:87:yy:yy:yy | 192.168.0.2 |
| . . . | . . . | . . . | . . . | . . . |

The user of the terminal apparatus 4 selects the printer whose configuration is sought to be changed from among the list of printers displayed on the apparatus information display unit 45 with the prescribed input peripheral device, and inputs the content of configuration change of the selected printer. For example, where the IP address of the printer 1 is to be changed, the user selects the printer 1 as the target apparatus of configuration change with the prescribed input peripheral device. In response to the user's selection, the apparatus information display unit 45 displays, for example, a configuration change input window including items of the printer 1 to be changed as shown in FIG. 10. The user inputs the content of configuration change into the configuration change input window with the prescribed input peripheral device. Specifically, while the apparatus information display unit 45 displays a screen exemplified in FIG. 9, the user selects the apparatus “NO. 1” corresponding to the printer 1 by performing operation such as left-clicking the IP address to be changed with a mouse. In response, the apparatus information display unit 45 displays a list, not shown in FIG. 9, of changeable configuration items of the printer 1 (including the configuration of the IP address). That is, the user makes the apparatus information display unit 45 of the terminal apparatus 4 display the configuration change input window as shown in FIG. 10 by performing operation such as left-clicking the IP address to be changed from among the list with the mouse. The user inputs a new value of the IP address and the like to the configuration change input window with a keyboard and the like, and clicks “OK” with the mouse and the like to finish this configuration change input operation.

FIG. 10 shows the configuration change input window when the user is inputting the content of the configuration change for the apparatus enclosed by a broken line box. It should be noted that the user does not have to input values to the items that need not be changed. The configuration content input unit 46 determines that it is necessary to change configuration of only the items whose values are changed, and calls the configuration data generator 42 passing the modified values as the parameters. The configuration data generator 42 makes the configuration data including the apparatus identifier, for example “12345678”, of the printer 1, the SET_IP command as described above, and the parameters including the values input by the user with the configuration content input unit 46 to change the configuration of the selected printer 1. The terminal apparatus 4 makes the communication controller 41 transmit the configuration data to the network NT via broadcast as described in FIG. 8.

Each of the printers 1 to 3 receives the configuration data transmitted from the terminal apparatus 4. The received data checker 23b calls the command interpreter 23c to interpret the command included in the configuration data and determines whether the command is supported. In this example, the command SET_IP is supported, and accordingly, the received configuration data is not discarded, and the apparatus identifier determination processor 23a is called. As described in FIG. 8, the apparatus identifier determination processor 23a of the printer 2 discards the configuration data without processing the configuration data because the apparatus identifier included in the configuration data is different from the apparatus identifier of the printer 2. Similarly, the apparatus identifier determination processor 23a of the printer 3 discards the configuration data without processing the configuration data because the apparatus identifier included in the configuration data is different from the apparatus identifier of the printer 3. In contrast, the apparatus identifier determination processor 23a of the printer 1 accepts the configuration data because the apparatus identifier included in the configuration data is the same as the apparatus identifier of the printer 1. Then, the apparatus identifier determination processor 23a of the printer 1 calls the configuration information access processor 24 to replace the configuration information stored in the configuration information memory 25 such as the IP address, the subnet mask, the default gateway of the printer 1, and the like with the information recited as the parameters of the command SET_IP in the configuration data according to the command SET_IP included in the configuration data, and calls the response data generator 23d passing the result of the replacing operation as parameters. In response, the response data generator 23d of the printer 1 makes the communication controller 21 transmit the response data to the terminal apparatus 4 via unicast as shown in FIG. 8.

In the image processing system, the configuration of the target printer can be changed upon exchanging the data between the printers 1 to 3 and the terminal apparatus 4 as shown in FIG. 8 where no duplicate apparatus identifier exists in the response data transmitted from the printers 1 to 3 to the terminal 4.

On the other hand, where the duplicate apparatus identifier is detected among the response data transmitted from the printers 1 to 3 to the terminal 4 in the image forming system, the data are exchanged between the printers 1 to 3 and the terminal apparatus 4 as shown in FIG. 11.

That is, where the response data interpreter 43 determines that the duplicate apparatus identifier exists, the terminal apparatus 4 calls the configuration data generator 42 to generate the configuration data including the duplicate apparatus identifier and the command RENEW_NUMBER as described above and makes the communication controller 41 transmit the generated configuration data to the network NT via broadcast. In this example, suppose that the apparatus identifiers of the printers 1, 2 are the same.

Each of the printers 1 to 3 receives the configuration data transmitted from the terminal apparatus 4 via the communication controller 21 and calls the received data checker 23b and the command interpreter 23c to interpret the command included in the configuration data to determine whether the command is supported. In this example, the received data checker 23b does not discard the received configuration data, and calls the apparatus identifier determination processor 23a because the command “RENEW_NUMBER” is supported. As shown in FIG. 11, the apparatus identifier determination processor 23a of the printer 3 discard the configuration data without processing the configuration data because the apparatus identifier included in the configuration data is different from the apparatus identifier of the printer 3. On the other hand, the apparatus identifier determination processors 23a of the printers 1, 2 accept the configuration data because the apparatus identifier included in the configuration data is the same as the apparatus identifiers of the printers 1, 2. Then, each of the apparatus identifier determination processors 23a of the printers 1, 2 calls the calculation unit 22a, the random number generator 22b, and the uptime acquiring unit 22c to generate the new apparatus identifier in response to the RENEW_NUMBER command included in the configuration data, and calls the response data generator 23d passing the generated apparatus identifier as the parameter. Each of the response data generators 23d of the printers 1, 2 generates the response data including the command NEW_NUMBER as described above in response to the command RENEW_NUMBER. Then, each of the printers 1, 2 transmits the response data to the terminal apparatus 4 via the communication controller 21 as shown in FIG. 11.

When the communication controller 41 of the terminal apparatus 4 receives the response data transmitted from each of the printers 1, 2, the terminal apparatus 4 calls the response data interpreter 43. The response data interpreter 43 interprets the command included in the response data, and where the command is NEW_NUMBER, the response data interpreter 43 determines again whether any duplicate apparatus identifier exists among the multiple response data. Where no duplicate apparatus identifier exists, the response data interpreter 43 retrieves information recited as the parameters in the response data such as the apparatus identifier, the MAC address, the IP address and the like, and stores the information about the apparatus in the apparatus information table 44 having a structure as described in FIG. 3 above. Where the duplicate apparatus identifier exists, the response data interpreter 43 calls the configuration data generator 42 to prepare again the configuration data including the duplicate apparatus identifier and the command RENEW_NUMBER as described above and make the communication controller 41 transmit the prepared configuration data to the network NT via broadcast.

In the image processing system, the data are exchanged as described above between the printers 1 to 3 and the terminal apparatus 4 until the duplicate apparatus identifier no longer exists. It should be noted that where the terminal apparatus 4 does not receive the response data within a prescribed period of time since the terminal apparatus 4 transmits the configuration data to the printers 1 to 3, the terminal apparatus 4 displays an error message read out of the error message memory 47 on the apparatus information display unit 45.

IP address configuration in the image processing system of the present invention is hereinafter described in detail.

First, steps performed by the printers 1 to 3 are hereinafter described with reference to FIGS. 12 to 17.

Upon start-up, each of the printers 1 to 3 makes the apparatus identifier checker 26 determine whether the apparatus identifier is already stored in the apparatus identifier memory 13a as shown in FIG. 12 at step S1. The printers 1 to 3 having the apparatus identifier already stored in the apparatus identifier memory 13a wait for the configuration data transmitted from the terminal apparatus 4 at step S3. On the other hand, the printers 1 to 3 having no apparatus identifier stored in the apparatus identifier memory 13a perform apparatus identifier generation processing at step S2, and proceed to step S3.

The printers 1 to 3 receiving the configuration data at step S4 perform configuration data reception processing at step S6, and repeat steps from step S3. On the other hand, the printers 1 to 3 receiving a shutdown request at step S5 while waiting for the configuration data at step S3 terminate this series of steps. It should be noted that the shutdown request is a command prepared separately from the commands in the configuration data.

The apparatus identifier generation processing at step S2 is hereinafter described.

For example, the apparatus identifier generation processing uses a pseudo random number generation function rand( ) and a function srand( ) changing a sequence of pseudo random numbers generated by the function rand( ) which are included in ANSI (American National Standard Institute) C standard functions. Specifically, the apparatus identifier generator 22 calls the uptime acquiring unit 22c to acquire the uptime since the printer is turned on as shown in FIG. 13 at step S11, the apparatus identifier generator 22 calls the random number generator 22b passing the uptime as the parameter to execute the function srand( ) to change the sequence of pseudo random number generation. It should be noted that the uptime of each of the printers 1 to 3 is counted in the unit of milliseconds, and such uptime of a prescribed number of digits is passed to the function srand( ) as the parameter, so that it is less likely that the sequence of pseudo random numbers generated by the function rand( ) of the printers 1 to 3 happens to be the same as one another.

Subsequently, the apparatus identifier generator 22 sets “0” as an initial value to a variable N counting the number of times of pseudo random number generation at step S13. Then, the apparatus identifier generator 22 determines at step S114 whether the number of times N is the same as the number of bytes of the apparatus identifier memory 13a as described above. In case of the example shown in FIG. 3 as described above, the number of bytes of the apparatus identifier memory 13a is 4 (four), and accordingly, the apparatus identifier generator 22 determines whether 4 (four) numbers are stored in the apparatus identifier memory 13a.

Where N=4, the apparatus identifier generator 22 terminates this series of steps because the pseudo random numbers are generated four times, that is, four pieces of information are generated to make up the apparatus identifier. Where N is not 4, the apparatus identifier generator 22 calls the calculation unit 22a at step S15 to execute the function rand( ) to generate the pseudo random number, and divide the generated pseudo random number by 255 and add 1 (one) to the remainder of the division at step S16. It should be noted that the reason why the remainder is calculated upon dividing the generated pseudo random number by 255 is that each area comprising the apparatus identifier memory 13a is 1 (one) byte and accordingly accommodates an integer of 1 to 255. The apparatus identifier generator 22 makes the apparatus information access processor 27 store the calculated result in the Nth area of the apparatus identifier memory 13a at step S117, and thereafter, adds 1 (one) to the number N of times of pseudo random number generation at step S18 and repeats steps from S14.

The apparatus identifier generator 22 repeats steps from S14 to S18 until the number N of times of pseudo random number generation becomes 4 (four), and stores the four calculated results in the apparatus identifier memory 13a.

Each of the printers 1 to 3 can generate the apparatus identifier by combining the four calculated results obtained from the processing as described above.

The configuration data reception processing of step S6 in FIG. 12 is hereinafter described.

When the printers 1 to 3 receive the configuration data transmitted from the apparatus 4, each of the printers 1 to 3 calls the command interpreter 23c to interpret the command included in the configuration data at step S21 as shown in FIG. 14, and makes the received data checker 23b determine whether the command is supported at step S22.

Where the received data checker 23b determines that the command is not supported, the received data checker 23b discards the configuration data and terminates this series of steps. Where the received data checker 23b determines that the command is supported, the received data checker 23b calls the apparatus identifier determination processor 23a to perform apparatus identifier checking processing of the apparatus identifier included in the configuration data at step S23. At step S24, where the apparatus identifier determination processor 23a determines that the apparatus identifier shows that the configuration data cannot be processed (NG) by the printer of itself, the apparatus identifier determination processor 23a discards the received configuration data, and terminates this series of steps. Where the received apparatus identifier shows that the configuration data can be processed (OK) by the printer of itself, the apparatus identifier determination processor 23a accepts the configuration data.

Then, each of the printers 1 to 3 initiates response data preparation processing at step S25, initiates response data generation processing at step S26, makes the communication controller 21 transmit the generated response data to the terminal apparatus 4 at step S27, and terminates this series of steps of the configuration data reception processing.

Each of the printers 1 to 3 can generate the response data according to the received configuration data by performing the steps as described above.

The apparatus identifier checking processing of step S23 in FIG. 14 is hereinafter described.

When the apparatus identifier checking processing starts, the apparatus identifier determination processor 23a determines whether the command included in the configuration data is GET_INFO at step S31 as shown in FIG. 15. Where the apparatus identifier determination processor 23a determines that the command is GET_INFO, the apparatus identifier determination processor 23a determines whether the apparatus identifier included in the configuration data is “NULL” at step S32. Where the apparatus identifier determination processor 23a determines that the apparatus identifier is “NULL”, the apparatus identifier determination processor 23a determines that the apparatus identifier “NULL” shows that the configuration data can be processed (OK), and terminates this series of steps of the apparatus identifier checking processing. Where the apparatus identifier determination processor 23a determines that the apparatus identifier is not “NULL”, the apparatus identifier determination processor 23a proceeds to step S33, and determines whether the apparatus identifier is the same as the apparatus identifier of the printer of itself. Where the apparatus identifier determination processor 23a determines that the apparatus identifier is the same as the apparatus identifier of printer of itself, the apparatus identifier determination processor 23a determines that the configuration data can be processed (OK) by the printer of itself, and terminates this series of steps of the apparatus identifier checking processing. Where the apparatus identifier determination processor 23a determines that the apparatus identifier is different from the apparatus identifier of the printer of itself, the apparatus identifier determination processor 23a determines that the configuration data cannot be processed (NG) by the printer of itself, and terminates this series of steps of the apparatus identifier checking processing.

Where the apparatus identifier determination processor 23a determines that the command is not GET_INFO at step S31, the apparatus identifier determination processor 23a proceeds to step S33, and determines whether the received apparatus identifier is the same as the apparatus identifier of the printer of itself. Where the apparatus identifier determination processor 23a determines that the received apparatus identifier is the same as the apparatus identifier of the printer of itself, the apparatus identifier determination processor 23a determines that the configuration data can be processed (OK) by the printer of itself, and terminates this series of steps of the apparatus identifier checking processing. Where the apparatus identifier determination processor 23a determines that the received apparatus identifier is different from the apparatus identifier of the printer of itself, the apparatus identifier determination processor 23a determines that the configuration data cannot be processed (NG) by the printer of itself, and terminates this series of steps of the apparatus identifier checking processing.

Each of the printers 1 to 3 can recognize the apparatus identifier and performs appropriate processing depending on the apparatus identifier by performing the above-described steps.

The response data preparation processing of step S25 in FIG. 14 is hereinafter described.

The printers 1 to 3 perform different steps as the response data preparation processing depending on the command included in the received configuration data. Upon initiating the response data preparation processing, the apparatus identifier determination processor 23a determines whether the command included in the configuration data is SET_IP at step S41 as shown in FIG. 16. Where the command is SET_IP, the apparatus identifier determination processor 23a calls the configuration information access processor 24 to: replace the IP address of the printer of itself stored in the configuration information memory 25 with the IP address recited as the parameter in the command SET_IP and store the result of replacing operation (OK/NG) in the configuration information memory 25 at step S42; replace the subnet mask of the printer of itself stored in the configuration information memory 25 with the subnet mask recited as the parameter in the command SET_IP and store the result of replacing operation (OK/NG) in the configuration information memory 25 at step S43; replace the default gateway of the printer of itself stored in the configuration information memory 25 with the default gateway recited as the parameter in the command SET_IP and store the result of replacing operation (OK/NG) in the configuration information memory 25 at step S44, and terminates this series of steps of the response data preparation processing.

Where the command is determined not to be SET_IP at step S41, the apparatus identifier determination processor 23a proceeds to step S45, and determines whether the command is RENEW_NUMBER. Where the command is RENEW_NUMBER, the apparatus identifier determination processor 23a calls the calculation unit 22a, the random number generator 22b, and the uptime acquiring unit 22c to perform the apparatus identifier generation processing as described in FIG. 13 above to generate the new apparatus identifier and store the generated apparatus identifier in the apparatus identifier memory 13a according to the command RENEW_NUMBER at step S46. Then, the apparatus identifier determination processor 23a acquires the newly generated apparatus identifier at step S47, calls the configuration information access processor 24 to acquire the MAC address of the printer of itself stored in the configuration information memory 25 at step S48, and terminates this series of steps of the response data preparation processing.

Where the command is determined not to be RENEW_NUMBER at step S45, the apparatus identifier determination processor 23a proceeds to step S49, and determines whether the command is GET_INFO. Where the command is not GET_INFO, the apparatus identifier determination processor 23a terminates this series of steps of the response data preparation processing because the command is not supported. Where the command is GET_INFO, the apparatus identifier determination processor 23a calls the apparatus information access processor 27 to acquire the apparatus identifier stored in the apparatus identifier memory 13a at step S50 and acquire the apparatus name stored in the apparatus information memory 13 step S51. Then, the apparatus identifier determination processor 23a calls the configuration information access processor 24 to acquire the MAC address of the printer of itself stored in the configuration information memory 25 at step S52 and acquire information such as the IP address and the like stored therein at step S53, and terminates this series of steps of the response data preparation processing.

Each of the printers 1 to 3 can prepare necessary information to generate the response data depending on the command by performing the steps as described above.

The response data generation processing of step S26 in FIG. 14 is hereinafter described.

The printers 1 to 3 perform different processing as the response data generation processing depending on the command included in the received configuration data. That is, when the response data generation processing is initiated, the response data generator 23d determines whether the command included in the configuration data is SET_IP at step S61 as shown in FIG. 17. Where the command is SET_IP, the response data generator 23d adds the command SETR_IP corresponding to the command SET_IP to the response data at step S62. The response data generator 23d adds the result of IP address replacing operation stored at step S42 in FIG. 16 to the response data at step S63, adds the result of subnet mask replacing operation stored at step S43 in FIG. 16 to the response data at step S64, adds the result of default gateway replacing operation stored at step S44 in FIG. 16 to the response data at step S65, and terminates this series of steps of the response data generation processing.

Where the command is determined not to be SET_IP at step S61, the response data generator 23d proceeds to step S66, and determines whether the command is RENEW_NUMBER. Where the command is RENEW_NUMBER, the response data generator 23d adds to the response data the command NEW_NUMBER responding to the command RENEW_NUMBER at step S67. Then, the response data generator 23d adds the apparatus identifier newly generated at step S47 in FIG. 16 to the response data at step S68, adds the MAC address acquired at step S48 in FIG. 16 to the response data at step S69, and terminates this series of steps of the response data generation processing.

Where the command is determined not to be RENEW_NUMBER at step S66, the response data generator 23d proceeds to step S70, and determines whether the command is GET_INFO. Where the command is not GET_INFO, the response data generator 23d terminates this series of steps of the response data generation processing because the command is not supported. Where the command is GET_INFO, the response data generator 23d adds to the response data the command GETR_INFO responding to the command GET_INFO at step S71. Then, the response data generator 23d adds the apparatus identifier acquired at step S50 in FIG. 16 to the response data at step S72, and adds the apparatus name acquired at step S51 in FIG. 16 to the response data at step S73. Then, the response data generator 23d adds the MAC address acquired at step S52 in FIG. 16 to the response data at step S74, adds information such as the IP address and the like acquired at step S53 in FIG. 16 to the response data at step S75, and terminates this series of steps of the response data generation processing.

Each of the printers 1 to 3 can generate the response data depending on the command by performing the steps as described above.

Processing of the terminal apparatus 4 is hereinafter described with reference to FIGS. 18 to 22.

When a prescribed printer administration utility program starts to run on the terminal apparatus 4 in response to the user's operation, the terminal apparatus 4 performs apparatus information collection processing at step S81, and performs apparatus information display processing at step S82 as shown in FIG. 18.

Then, where the user requests to display the apparatus information at step S83, the terminal apparatus 4 repeats steps S81 and S82. Where the user does not request to display the apparatus information, the terminal apparatus 4 determines whether the user requests to configure the printer at step S84.

Where the user does not request to configure the printer, the terminal apparatus 4 determines whether the user requests to terminate the utility program at step S85. Where the user requests to terminate the utility program, the terminal apparatus 4 terminates this series of processing. Where the user does not request to terminate the utility program, the terminal apparatus 4 repeats steps from step S83, and waits until the user requests to display the apparatus information or requests to configure the printer.

Where the user requests to configure the printer at step S84, the terminal apparatus 4 proceeds to apparatus configuration processing at step S86. Upon performing the apparatus configuration processing, the terminal apparatus 4 goes into a standby state waiting for the user to request to display the apparatus information or request to configure the printer until the user requests to terminate the utility program.

The apparatus information collection processing at step S81 is hereinafter described.

When the utility program starts to run, the terminal apparatus 4 calls the configuration data generator 42. The configuration data generator 42 adds the command GET_INFO to the configuration data at step S91, and adds the apparatus identifier “NULL” to the configuration data as shown in FIG. 19. Then, the terminal apparatus 4 makes the communication controller 41 transmit the configuration data to the network NT via broadcast at step S93.

The terminal apparatus 4 can collect the apparatus information of the printers 1 to 3 connected to the network NT by performing the steps as described above.

The apparatus information display processing of S82 in FIG. 18 is hereinafter described.

The terminal apparatus 4 performs the apparatus information collection processing to transmit the configuration data including the command GET_INFO to the network NT, and performs the apparatus information display processing based on the received response data responding to the configuration data. Specifically, the terminal apparatus 4 determines whether the terminal apparatus 4 receives the response data transmitted from any one of the printers at step S101 in FIG. 20. Where the terminal apparatus 4 does not receive the response data, the terminal apparatus 4 determines whether a prescribed period of time passes since the transmission of the configuration data, namely, determines whether it times out at step S108. Where it times out, the terminal apparatus 4 proceeds to step S109. Where it has not yet timed out, the terminal apparatus 4 repeats steps from step S101. That is, the terminal apparatus 4 keeps on trying to receive the response data from the printers 1 to 3 until it times out.

Where the terminal apparatus 4 receives the response data, the terminal apparatus 4 calls the response data interpreter 43 to interpret the command included in the response data at step S102, determines whether the command is GETR_INFO at step S103. Where the command is not GETR_INFO, the terminal apparatus 4 proceeds to step S110. Where the command is GETR_INFO, the terminal apparatus 4 retrieves the apparatus identifier recited as the parameter in the response data and stores the apparatus identifier in the apparatus information table 44 at step S104, and the terminal apparatus 4 retrieves the apparatus name recited as the parameter in the response data and stores the apparatus name in the apparatus information table 44 at step S105. Further, the terminal apparatus 4 retrieves the MAC address recited as the parameter of the response data and stores the MAC address in the apparatus information table 44 at step S106, and the terminal apparatus 4 retrieves information such as the IP address and the like recited as the parameter in the response data and stores the IP address and the like in the apparatus information table 44 at step S107. Every time the terminal apparatus 4 receives the response data having the command GETR_INFO, the terminal apparatus 4 retrieves information from the response data and stores the information in the apparatus information table 44 as described above.

Where the prescribed period of time passes since the terminal apparatus 4 transmits the configuration data, namely, it times out at step S108, the terminal apparatus 4 calls the response data interpreter 43 to perform duplicate checking processing at step S109 that determines whether any duplicate apparatus identifier exists. Then, the terminal apparatus 4 displays the content of the apparatus information table 44 on the apparatus information display unit 45 as shown in FIG. 9 at step S110, and terminates this series of steps of the apparatus information display processing.

The terminal apparatus 4 can display on the apparatus information display unit 45 the apparatus information about the printers 1 to 3 connected to the network NT by performing the steps as described above.

The duplicate checking processing of step S109 is hereinafter described.

When the duplicate checking processing of the apparatus identifier is initiated, the terminal apparatus 4 calls the response data interpreter 43 to sort the response data received from each of the printers in descending order by the apparatus identifier at step S121 as shown in FIG. 21. The response data interpreter 43 determines whether any duplicate apparatus identifier exists among the sorted response data at step S122. Where no duplicate apparatus identifier exists, the terminal apparatus 4 terminates this series of steps of the duplicate checking processing of the apparatus identifier. Where the duplicate apparatus identifier exists, the terminal apparatus 4 calls the configuration data generator 42 to add the command RENEW_NUMBER to the configuration data at step S123, and adds the duplicate apparatus identifier to the configuration data as the apparatus identifier at step S124. Then, the terminal apparatus 4 makes the communication controller 41 transmit the configuration data to the network NT via broadcast at step S125.

Upon transmitting the configuration data, the terminal apparatus 4 determines whether the terminal apparatus 4 receives the response data transmitted from any one of the printers at step S126. Where the terminal apparatus 4 does not receive the response data, the terminal apparatus 4 determines whether the prescribed period of time passes since the transmission of the configuration data, namely, determines whether it times out at step S129. Where it has not yet timed out, the terminal apparatus 4 repeats steps from step S126. Where it times out, the terminal apparatus 4 reads out an error message indicating the timeout error from the error message memory 47 to display the error message on the apparatus information display unit 45 at step S130, and terminates this series of steps of the duplicate checking processing.

Where the terminal apparatus 4 receives the response data transmitted from any one of the printers at step S126, the terminal apparatus 4 calls the response data interpreter 43 at step S127 to acquire information such as the apparatus identifier, the MAC address, and the like recited as the parameters in the response data including the command NEW_NUMBER. Then, the terminal apparatus 4 determines whether the terminal apparatus 4 has received the response data from all the printers having the duplicate apparatus identifier based on the number of the printers having the duplicate apparatus identifier and the number of the received response data at step S128. Where the terminal apparatus 4 has not yet received the response data from all the printers having the duplicate apparatus identifier, the terminal apparatus 4 proceeds to step S129. Where the terminal apparatus 4 has received the response data from all the printers having the duplicate apparatus identifier, the terminal apparatus 4 repeats steps from step S121.

The terminal apparatus 4 performs the steps as described above, so that the terminal apparatus 4 can determine whether any duplicate apparatus identifier exists and can make the printers generate the new apparatus identifiers in place of the old duplicate apparatus identifier to solve the duplication.

The apparatus configuration processing of step S86 in FIG. 18 is hereinafter described.

Where the user requests to configure the printer, the terminal apparatus 4 performs the apparatus configuration processing. Specifically, as shown in FIG. 22, the terminal apparatus 4 determines whether the user requests to change configuration of the printer such as IP address and the like at step S141. Where the user requests to change the configuration of the printer, the terminal apparatus 4 calls the configuration data generator 42 to add to the configuration data the apparatus identifier of the printer whose configuration is sought to be changed at step S142, and the terminal 4 adds the command SET_IP to the configuration data at step S143. At steps S144 to S146, the terminal apparatus 4 adds to the configuration data the value of the IP address, the subnet mask, and the default gateway that the user inputs as the parameters of the configuration data. Then, the terminal apparatus 4 makes the communication controller 41 transmit the configuration data to the network NT via broadcast at step S147, and terminates this series of steps of the apparatus configuration processing.

The terminal apparatus 4 can change the configuration of the printer by performing the steps as described above. In the image processing system, the configuration data transmitted from the terminal apparatus 4 thus remotely configure the IP addresses and the like of the printers over the network NT as described above, so that the printers 1 to 3, the terminal apparatus 4, and other apparatuses, not shown, on the network NT can communicate with each other using the IP addresses thus configured, and the user can print to the printers over the network NT.

As hereinabove described, the image processing system of the first embodiment of the present invention enables various configuration including the IP address of the multiple printers 1 to 3 to be changed over the network NT. Further, the image processing system does not require the user to manually configure the apparatus identifier distinguishing the multiple printers 1 to 3 on the network NT, so that the user can easily and surely configure the IP addresses and the like of the printers remotely from the terminal apparatus 4 over the network NT without being forced to do cumbersome work.

The image processing system according to the second embodiment of the present invention is hereinafter described.

In the image processing system of the second embodiment, the apparatus identifier is generated based on a timestamp message received from NTP (Network Time Protocol) Server. In the description of the second embodiment, the same reference numerals as the first embodiment are given to the structure similar to the first embodiment, and the detailed description thereabout is omitted.

As shown in FIG. 23, the multiple printers 1 to 3, the terminal apparatus 4 connected to the printers 1 to 3 to serve as the host apparatus thereof, and an NTP server 5 distributing the timestamp message are connected over the network NT with each other to form the image processing system.

FIG. 24 is the block diagram of the printers 1 to 3. Only the printer 1 is hereinafter described because all of the printers 1 to 3 have substantially the same structure. In addition to the image formation/print unit 11 and the apparatus information memory 13 as described above, the printer 1 of the second embodiment has a network card 101 serving as the network interface unit detachably attached to the printer 1 and communicating over the network NT. That is, the printer 1 of the second embodiment does have the uptime timer 12 that the printer 1 of the first embodiment has, but the printer 1 of the second embodiment has the network card 101 in place of the network card 14 of the first embodiment.

The network card 101 has the apparatus identifier generator 22, the data controller 23, the configuration information access processor 24, the configuration information memory 25, the apparatus identifier checker 26, and the apparatus information access processor 27, and the communication controller 111 in place of the communication controller 21 as described above.

The communication controller 111 controls communication with other apparatuses such as the terminal apparatus 4 connected to the network NT in the same way as the communication controller 21 as described above. Especially, the communication controller 111 has an NTP server access control unit 111a to access the NTP server 5 connected to the network NT to obtain the timestamp message distributed by the NTP server 5. The NTP server access control unit 111a provides the obtained timestamp message to the apparatus identifier generator 22 via the data controller 23.

In the image processing system having the printers 1 to 3 as described above, each of the printers 1 to 3 performs the series of steps as shown in FIG. 12. Each of the printers 1 to 3 performs the steps shown in FIG. 25 instead of the steps in FIG. 13 as the apparatus identifier generation processing of step S2 in FIG. 12.

The apparatus identifier generator 22 obtains the timestamp message from the NTP server 5 via the NTP server access controller 111a at step S201 in FIG. 25. The apparatus identifier generator 22 uses the Transmit Timestamp in the obtained timestamp message to generate the apparatus identifier. The apparatus identifier generator 22 calls the random number generator 22b at step S202 to execute the function srand( ) passing the obtained Transmit Timestamp as the parameter to change the sequence of the random number generation.

Subsequently, the apparatus identifier generator 22 sets “0” as the initial value to the number N of times of pseudo random number generation at step S203. Then, the apparatus identifier generator 22 determines whether the number N of times of pseudo random number generation is the same as the number of bytes of the apparatus identifier memory 13a as described above at step S204. In the example of FIG. 3, the number of bytes of the apparatus identifier memory 13a is 4 (four), and accordingly, the apparatus identifier generator 22 determines whether four random numbers have been stored in the apparatus identifier memory 13a.

Where N=4, the apparatus identifier generator 22 terminates this series of steps of the apparatus identifier generation processing. Where N is not 4, the apparatus identifier generator 22 calls the calculation unit 22a at step S205 to execute the function rand( ) to generate the pseudo random number, and divide the generated pseudo random number by 255 and add 1 (one) to the remainder of the division at step S206. Then, the apparatus identifier generator 22 makes the apparatus information access processor 27 store the calculated result in the Nth area of the apparatus identifier memory 13a at step S207, and thereafter, adds 1 (one) to the number N of times of pseudo random number generation at step S208 and repeats steps from S204.

The apparatus identifier generator 22 repeats steps from S204 to S208 until the number N of times of pseudo random number generation becomes 4 (four), and stores the four calculated results in the apparatus identifier memory 13a.

Each of the printers 1 to 3 can generate the apparatus identifier by combining the four calculated results obtained from the steps as described above.

As described above, the image processing system of the second embodiment of the present invention can automatically generate the apparatus identifier by accessing the NTP server 5 on the network NT even where the printers 1 to 3 do not have a time measuring means such as the uptime timer 12, and thus, the image processing system of the second embodiment can easily and surely change various configuration including the IP addresses of the multiple printers 1 to 3 remotely over the network NT.

The image processing system according to the third embodiment of the present invention is hereinafter descried.

The image processing system of the third embodiment is applicable where the printer has multiple network cards. In the description of the third embodiment, the same reference numerals as the first embodiment are given to the structure similar to the first embodiment, and the detailed description thereabout is omitted.

In the image processing system of the third embodiment, the multiple printers 1 to 3 and the terminal apparatus 4 connected to the printers 1 to 3 to serve as the host apparatus thereof are connected over the network NT with each other to form the image processing system as shown in FIG. 1.

FIG. 26 is the block diagram of the printers 1 to 3. Only the printer 1 is hereinafter described because all of the printers 1 to 3 have substantially the same structure. In addition to the image formation/print unit 11 and the uptime timer 12 as described above, the printer 1 of the third embodiment has network cards 14a and 14b, the apparatus information memory 201 storing the apparatus information including the apparatus identifier of the printers 1 to 3, and a device administration unit 202 managing information about the network cards 14a and 14b. That is, the printer 1 of the third embodiment has the apparatus information memory 201 in place of the apparatus information memory 13 of the first embodiment, and has the device administration unit 202 and the network cards 14a and 14b that do not exist in the first embodiment.

Each of the network cards 14a and 14b has the similar structure as the network card 14 as described above. Each of the network cards 14a and 14b is installed in a different slot of the printer 1, and communicates with other apparatuses over the networks NT1 and NT2, respectively.

The apparatus information memory 201, just like the apparatus information memory 13, has the apparatus identifier memory 13a storing the apparatus identifier of the printer 1, and stores the apparatus information including the apparatus identifier and the apparatus name of the printer 1. The apparatus information memory 201 has a slot information memory 201a storing slot information detected by the device administration unit 202 as hereinafter described. As shown in FIG. 27, the size of the apparatus identifier memory 13a is a prescribed number of bytes, and the apparatus identifier memory 13a has as many areas as the number N of times of pseudorandom number generation, and stores information generated by the apparatus identifier generator 22 in each of the areas under the control of an apparatus information access processor 27 in the network card 14. It is to be noted that FIG. 27 shows a case where N=4 and the areas has the four one-byte areas for storing the information. The apparatus identifier memory 13a has another area for storing the slot information retrieved from the slot information memory 201a next to the areas arranged for the number N of times of pseudo random number generation. The apparatus identifier is made by combining the information stored in each of the areas as described above.

The device administration unit 202 manages information about the network cards 14a and 14b such as the number and the type of network cards 14a and 14b connected to the printer 1, the slot information, and the like. The slot information means an administrative number and the like assigned to each of the slots to manage the positions of the slots in which the network cards 14a and 14b are installed. When the printer 1 starts up or when the network card is additionally installed, the device administration unit 202 acquires the information about the network cards 14a and 14b, and stores the slot information to the slot information memory 201a in the apparatus information memory 201.

In the image processing system having the printers 1 to 3, each of the printers 1 to 3 performs the series of steps in FIG. 12 as described above. When the steps in FIG. 12 are performed, each of the printers 1 to 3 performs the series of steps shown in FIG. 28 in place of the steps in FIG. 13 as the apparatus identifier generation processing of step S2 in FIG. 12. The steps in FIG. 13 are once performed to generate the apparatus identifier for the network card 14a, and are once again performed to generate the apparatus identifier for the network card 14b.

That is, the apparatus identifier generator 22 calls the uptime acquiring unit 22c to acquire the uptime since the printer 1 is turned on at step S301, and calls the random number generator 22b to execute the function srand( ) passing the uptime as the parameter at step S302 as shown in FIG. 28.

Then, the apparatus identifier generator 22 sets “0” (zero) to the number N of times of pseudo random number generation at step S303. Then, the apparatus identifier generator 22 determines whether the number N of times of pseudo random number generation is the same as the number of bytes of the areas of the apparatus identifier memory 13a excluding the area storing the slot information at step S304. In the example of FIG. 27, the size of the apparatus identifier memory 13a is 4 (four) bytes excluding the area storing the slot information, and thus, it should be understood that four pieces of information can be stored in the apparatus identifier memory 13a.

Where N is not 4, the apparatus identifier generator 22 calls the calculation unit 22a at step S305 to execute the function rand( ) to generate the pseudo random number, and divide the generated pseudo random number by 255 and add 1 (one) to the remainder of the division at step S306. Then, the apparatus identifier generator 22 makes the apparatus information access processor 27 store the calculated result in the Nth area of the apparatus identifier memory 13a at step S307, and thereafter, adds 1 (one) to the number N of times of pseudo random number generation at step S308 and repeats steps from S304.

The apparatus identifier generator 22 repeats steps S304 to S308 until the number N of times of pseudo random number generation becomes 4 (four), and stores the four calculated results in the apparatus identifier memory 13a. Where the steps are repeated and N becomes 4 (four), the apparatus identifier generator 22 retrieves the slot information from the slot information memory 201a, stores the slot information in the apparatus identifier memory 13a at step S309, and terminates this series of steps of the apparatus identifier generation processing.

Each of the printers 1 to 3 can generate the apparatus identifier by combining the four calculated results obtained from the processing as described above.

As described above, the image processing system of the third embodiment of the present invention can automatically generate the apparatus identifiers for each of the network cards 14a and 14b without previously configuring the apparatus identifiers even where the printers 1 to 3 have the multiple network cards 14a and 14b, and thus, the image processing system of the third embodiment can easily and surely change the configuration including the IP address of the multiple printers 1 to 3 remotely over the network NT.

Lastly, the image processing apparatus according to the fourth embodiment of the present invention is hereinafter described.

The image processing system of the fourth embodiment generates the apparatus identifier based on the time information retrieved from a real-time clock. In the description of the fourth embodiment, the same reference numerals as the first embodiment are given to the structure similar to the first embodiment, and the detailed description thereabout is omitted.

In the image processing system of the fourth embodiment, the multiple printers 1 to 3 and the terminal apparatus 4 connected to the printers 1 to 3 to serve as the host apparatus thereof are connected over the network NT with each other to form the image processing system as shown in FIG. 1.

FIG. 29 is the block diagram of the printers 1 to 3. Only the printer 1 is hereinafter described because all of the printers 1 to 3 have substantially the same structure. In addition to the image formation/print unit 11, the apparatus information memory 13, and the network card 14, the printer 1 of the fourth embodiment has a real-time clock 301 keeping track of the current time, a time display unit 302 displaying the current time provided by the real-time clock 301, and a backup circuit 302 providing electricity to the real-time clock 301. That is, the printer 1 of the fourth embodiment does not have the uptime timer 12 of the first embodiment, and has the real-time clock 301, the time display unit 302, and the backup circuit 303 that the printer 1 of the first embodiment does not have.

The real-time clock 301 is an integrated circuit for providing data such as the current year, month, day, hour, minute, and second. The real-time clock 301 runs on electricity provided by the backup circuit 303 from power-off to startup so that the real-time clock 301 keeps on running while the printer 1 is turned off, and the printer 1 runs on electricity provided by the main poser source of the printer 1 while the printer 1 is turned on. The time information provided by the real-time clock 301 is supplied to the time display unit 302 and the apparatus identifier generation unit 22.

The time display unit 302 displays the current time provided by the real-time clock 301.

The backup circuit 303 is comprised of a battery and the like that are different from the main power source of the printer 1, and provides the electricity for driving the real-time clock from power-off to start-up of the printer 1.

In the image processing system having the printers 1 to 3 as described above, each of the printers 1 to 3 performs the steps in FIG. 12 as described above. Each of the printers 1 to 3 performs the steps in FIG. 30 in place of the steps in FIG. 13 as the apparatus identifier generation processing of step S2 in FIG. 12.

That is, the apparatus identifier generation unit 22 retrieves the current time from the real-time clock 301 at step S401, and calls the random number generator 22b to execute the function srand( ) passing the acquired current time as the parameter to change the sequence of pseudo random number generation at step S402 as shown in FIG. 30.

Then, the apparatus identifier generation unit 22 sets “0” as the initial value to the number N of times of pseudo random number generation at step S403. Then, the apparatus identifier generation unit 22 determines whether the number N of times of random number generation is the same as the number of bytes of the apparatus identifier memory 13a at step S404. In the example of FIG. 3, the number of bytes of the apparatus identifier memory 13a is 4 (four), and accordingly, the apparatus identifier generator 22 determines whether four random numbers have been stored in the apparatus identifier memory 13a.

Where N=4, the apparatus identifier generator 22 terminates this series of steps of the apparatus identifier generation processing. Where N is not 4, the apparatus identifier generator 22 calls the calculation unit 22a at step S405 to execute the function rand( ) to generate the pseudo random number, and divide the generated pseudo random number by 255 and add 1 (one) to the remainder of the division at step S406. Then, the apparatus identifier generator 22 makes the apparatus information access processor 27 store the calculated result in the Nth area of the apparatus identifier memory 13a at step S407, and thereafter, adds 1 (one) to the number N of times of pseudo random number generation at step S408 and repeats steps from S404.

The apparatus identifier generator 22 repeats steps from S404 to S408 until the number N of times of pseudo random number generation becomes 4 (four), and stores the four calculated results in the apparatus identifier memory 13a.

Each of the printers 1 to 3 can generate the apparatus identifier by combining the four calculated results obtained from the steps as described above.

As described above, the image processing system of the fourth embodiment of the present invention can automatically generate the apparatus identifier by using the existing real-time clock 301 arranged in the printer 1, 2, and 3, and thus, the image processing system of the fourth embodiment can easily and surely change various configuration including the IP address of the multiple printers 1 to 3 remotely over the network NT.

The present invention is not limited to the embodiment as described above. For example, although the commands are comprised of text strings in the above embodiments, but the command may be comprised of a number or numbers in the present invention.

Although the apparatus identifier is generated based on the generated pseudo random numbers in the above embodiments, any means can be employed to generate the apparatus identifier as long as the apparatus identifier is generated based on numbers generated according to a prescribed rule other than pseudo random numbers in the present embodiment.

In the description of the above first embodiment of the present invention, the response data received from each of the printers are sorted in descending order by the apparatus identifier in the duplicate checking processing of the apparatus identifier performed by the terminal apparatus 4. However, the response data may be sorted according to any criteria in the present invention, and for example, the response data may be sorted in ascending order.

In the description of the above second embodiment of the present invention, the apparatus identifier is generated based on the time information obtained from the NTP server. However, the invention is not limited to the NTP server, and any server can be used for the present invention as long as the server can provide the time information.

In the description of the above second embodiment of the present invention, Transmit Timestamp in the retrieved timestamp message is used to generate the apparatus identifier. However, the present invention is not limited to Transmit Timestamp, and any time information can be used for the present invention.

In the description of the above third embodiment of the present invention, the printer has two network cards, namely, the network cards 14a and 14b. However, the invention is not limited thereto, and any number of network cards can be used.

In the description of the above third embodiment of the present invention, the slot information means the administrative numbers and the like assigned to manage the locations of the slots in which the network cards 14a and 14b are installed. However, the present invention is not limited thereto, and the slot information can be the administrative number uniquely assigned to not only the network cards but also all other interface cards.

In the description of the above third embodiment of the present invention, the apparatus identifier is generated based on the uptime information retrieved from the uptime timer 12 in the same way as the first embodiment. However, the printer having the multiple network cards may generate the apparatus identifier based on the time information acquired from the outside of the printer or some other unit inside of the printer as described in the second or fourth embodiments.

In the description of the above embodiments, the printer has the image formation/print unit 11 to form an image on a prescribed recording medium such as paper based on the input data. However, the present invention can be applied to any image processing apparatus performing image processing based on the data received over the network, and for example, the invention is preferably applied to a facsimile machine, a copier, and other apparatuses having multiple functions.

In the embodiments, the multiple printers and the computer are connected over the TCP/IP network on Ethernet. However, this invention is not limited to the TCP/IP network or Ethernet, and this invention can be applied to any communication protocol that uses addresses or identifiers to allow communication between apparatuses.

Needless to say, the present invention can be changed arbitrarily without deviating from the scope of the spirit of the invention.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An image processing apparatus performing image processing based on data received over a prescribed network, the image processing apparatus comprising:
a number generator generating a number according to a prescribed rule;
an apparatus identifier generator using the number generated by the number generator to generate an apparatus identifier distinguishing the image processing apparatus;
a communication controller transmitting the apparatus identifier generated by the apparatus identifier generator and receiving address information of a prescribed communication protocol together with the apparatus identifier via the network; and
a communication configuration memory storing the address information received by the communication controller,
wherein the communication controller uses the address information stored in the communication configuration memory to communicate data with another apparatus on the network.

2. The image processing apparatus according to claim 1, wherein the communication controller changes the address information stored in the communication configuration memory where the communication controller receives a request for changing the address information via the network.

3. The image processing apparatus according to claim 1, wherein the apparatus identifier generator generates the new apparatus identifier when the communication controller receives a request for regenerating the apparatus identifier via the network, and wherein the communication controller transmits the new apparatus identifier generated by the apparatus identifier generator via the network.

4. The image processing apparatus according to claim 1, wherein the number generator is a random number generator generating a pseudo random number.

5. The image processing apparatus according to claim 4 further comprising an uptime timer measuring an uptime of the image processing apparatus since the image processing apparatus is turned on, and wherein the random number generator changes a sequence of random number generation based on the uptime obtained from the uptime timer and generates a pseudo random number.

6. The image processing apparatus according to claim 4 further comprising a time information acquiring unit acquiring time information, and wherein the random number generator changes a sequence of random number generation based on the time information acquired by time information acquiring unit and generates a pseudo random number.

7. The image processing apparatus according to claim 6, wherein the time information acquiring unit acquires the time information from a prescribed external apparatus via the network.

8. The image processing apparatus according to claim 4 further comprising a clock keeping track of the current time, wherein the random number generator changes a sequence of random number generation based on the current time obtained from the clock and generates a pseudo random number.

9. The image processing apparatus according to claim 1 further comprising a device administration unit managing information about a plurality of network interface units connecting to a plurality of networks, and wherein the apparatus identifier is generated by the apparatus identifier generator for each of the plurality of network interface units.

10. An image processing system comprising:
a host apparatus connected to a prescribed network; and
an image processing apparatus performing image processing based on data received from the host apparatus via the network,
wherein the image processing apparatus comprising:
a number generator generating a number according to a prescribed rule;
an apparatus identifier generator uses the number generated by the number generator to generate an apparatus identifier distinguishing the image processing apparatus;
a communication controller transmitting the apparatus identifier generated by the apparatus identifier generator and receiving address information of a prescribed communication protocol together with the apparatus identifier via the network; and
a communication configuration memory storing the address information received by the communication controller,
wherein the communication controller uses the address information stored in the communication configuration memory to communicate data with another apparatus via the network.

11. The image processing system according to claim 10, wherein the communication controller changes the address information stored in the communication configuration memory where the communication controller receives a request for changing the address information via the network.

12. The image processing system according to claim 10, wherein the apparatus identifier generator generates the new apparatus identifier when the communication controller receives a request for regenerating the apparatus identifier via the network, and wherein the communication controller transmits the new apparatus identifier generated by the apparatus identifier generator via the network.

13. The image processing system according to claim 10, wherein the number generator is a random number generator generating a pseudo random number.

14. The image processing system according to claim 13 further comprising an uptime timer measuring an uptime of the image processing apparatus since the image processing apparatus is turned on, and wherein the random number generator changes a sequence of random number generation based on the uptime obtained from the uptime timer and generates a pseudo random number.

15. The image processing system according to claim 13 further comprising a time information acquiring unit acquiring time information, and wherein the random number generator changes a sequence of random number generation based on the time information acquired by time information acquiring unit and generates a pseudo random number.

16. The image processing system according to claim 15, wherein the time information acquiring unit acquires the time information from a prescribed external apparatus via the network.

17. The image processing system according to claim 13 further comprising a clock keeping track of the current time, wherein the random number generator changes a sequence of random number generation based on the current time obtained from the clock and generates a pseudo random number.

18. The image processing system according to claim 1 further comprising a device administration unit managing information about a plurality of network interface units connecting to a plurality of networks, and wherein the apparatus identifier is generated by the apparatus identifier generator for each of the plurality of network interface units.

19. The image processing system comprising:
a host apparatus connected to a network and having a first network address assigned to the host apparatus; and
an image processing apparatus connected to the network and having a second network address assigned to the image processing apparatus,
wherein the image processing apparatus changes the second network address to a third network address according to the steps of:
receiving an apparatus identifier generation request transmitted from the host apparatus to a broadcast address of the network;
generating a first apparatus identifier according to a prescribed rule;
storing the generated first apparatus identifier in a memory of the image processing apparatus;
transmitting a response data including the generated first apparatus identifier to the first network address over the network in reply to the apparatus identifier generation request;
receiving a network address change request including a second apparatus identifier and the third network address transmitted from the host apparatus to the broadcast address of the network;
determining where the received second apparatus identifier is the same as the first apparatus identifier stored in the memory of the image processing apparatus;
changing the second network address of the image processing apparatus to the received third network address where the received second apparatus identifier is the same as the first apparatus identifier.

20. The image processing system according to claim 12, wherein the network is a TCP/IP network.

21. The image processing system according to claim 12, wherein the first network address, the second network address, and the third network address are IP addresses.
